(19) United States
(12) Patent Application Publication
(10) Pub. No.: US 2021/0019953 A1
(43) Pub. Date: Jan. 21, 2021

(54) REAL-TIME FEEDBACK FOR SURFACE RECONSTRUCTION AS A SERVICE

(71) Applicant: MICROSOFT TECHNOLOGY LICENSING, LLC, Redmond, WA (US)

(72) Inventors: Yuri Pekelny, Seattle, WA (US); Michael Bleyer, Seattle, WA (US); Raymond Kirk Price, Redmond, WA (US)

(21) Appl. No.: 16/512,826

(22) Filed: Jul. 16, 2019

(51) Int. Cl. G06T 19/20; G06T 7/32; G06T 17/20; G06T 19/00; G01C 21/20

(52) U.S. Cl. CPC G06T 19/20; G06T 7/32; H04W 84/12; G06T 19/006; G01C 21/206; G06T 17/20

(57) ABSTRACT

Techniques for improving how surface reconstruction data is prepared and passed between multiple devices are disclosed. For example, an environment is scanned to generate 3D scanning data. This 3D scanning data is then transmitted to a central processing service. The 3D scanning data is structured or otherwise configured to enable the central processing service to generate a digital 3D representation of the environment using the 3D scanning data. Reduced resolution representation data is received from the central processing service. This reduced resolution representation data was generated based on 3D scanning data generated by one or more other computer systems that were also scanning the same environment. A first visualization corresponding to the original 3D scanning data is then displayed simultaneously with one or more secondary visualization(s) corresponding to the reduced resolution representation data.

### BACKGROUND

Mixed-reality (MR) systems/devices include virtual-reality (VR) and augmented-reality (AR) systems. Conventional VR systems create completely immersive experiences by restricting users' views to only virtual images rendered in VR scenes/environments. Conventional AR systems create AR experiences by visually presenting virtual images that are placed in or that interact with the real world. As used herein, VR and AR systems are described and referenced interchangeably via use of the phrase “MR system.” As also used herein, the phrases “virtual image,” “virtual content,” and “hologram” refer to any type of digital image rendered by an MR system. Furthermore, it should be noted that a head-mounted device (HMD) typically provides the display used by the user to view and/or interact with holograms provided within an MR scene. As used herein, “HMD” and “MR system” can be used interchangeably with one another. HMDs and MR systems are also examples of “computer systems.”

MR systems are emerging as a highly beneficial device for many different types of organizations, events, and people, including first responders (e.g., firefighters, policemen, medics, etc.). For instance, FIG. 1 illustrates an example of a building 100 that is currently on fire. Here, building 100 has numerous different floors, with each floor having its own floor layout (e.g., floor layout 105 showing different rooms relative to one another). In the situation shown in FIG. 1, there is a baby 110 located in one of the rooms of building 100. In this case, it is highly desirable for first responders (e.g., first responder 115 and first responder 120) to be able to quickly navigate their way through the building 100 to locate and rescue the baby 110.

Some techniques have been developed to enable an HMD to acquire and display a blueprint of a building, which would help users know how best to navigate through the rooms of the building. As an example, using a blueprint, first responders 115 and 120, who may be using an HMD, can quickly navigate through the building to find and rescue the baby 110. As such, use of HMDs truly do have great benefits and can be instrumental in saving countless lives.

While HMDs have provided substantial benefits in emergency scenarios, their use can be improved even further. For instance, in emergency scenarios, it is highly desirable to quickly and efficiently “clear” rooms by checking to see whether a person, animal, or prized possession is located within those rooms. While current techniques are in place to help guide users (e.g., first responders) in simply navigating different rooms via blueprint data, there is a substantial need (especially in emergency scenarios) to coordinate the activities of multiple users to facilitate efficient sweeping, scanning, and clearing of rooms in an environment.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The disclosed embodiments relate to systems, methods, and other devices (e.g., HMDs or computer-readable hardware storage devices) that improve the coordination between multiple scanning devices used to map or scan an environment. By improving this coordination, the embodiments reduce redundancy and significantly increase scanning efficiency.

In some embodiments, a computer system (e.g., an HMD/MR system) can be used to scan an environment to generate three-dimensional (3D) scanning data of the environment. This 3D scanning data is transmitted to a central processing service, which uses the 3D scanning data to generate a digital 3D representation of the environment. So-called “reduced resolution representation data” is then received by the computer system from the central processing service. The reduced resolution representation data was generated using other 3D scanning data generated by one or more other computing system(s), which were scanning the same environment during the same time period as when the computer system was performing its scan. The computer system then renders a first visualization, which corresponds to the 3D scanning data, simultaneously with one or more secondary visualization(s), which corresponding to the reduced resolution representation data.

In some embodiments, a central processing service provides real-time feedback to multiple computing systems to enable those systems to visually differentiate between areas in an environment that have been scanned via surface reconstruction scanners (e.g., up to at least a particular scanning threshold) and areas in the environment that have not been scanned (e.g., up to the particular scanning threshold). To do so, the central processing service receives, from the multiple computing systems, 3D scanning data describing a common environment in which the multiple computing systems are located. Subsequent to receiving the 3D scanning data, the central processing service performs a number of operations. For instance, the service uses the 3D scanning data to generate (or update) a 3D surface reconstruction mesh describing the environment three-dimensionally. Additionally, the service uses the 3D scanning data to generate multiple sets of reduced resolution representation data, with a corresponding set being generated for each one of the computing systems. Each one of these sets describes one or more area(s) within the environment that were scanned up to the particular scanning threshold by that set's corresponding computing system. Then, for each set of reduced scanning data, the service transmits that set to each one of the computing systems except for that set's corresponding computing system. Consequently, the service refrains from transmitting the set to that set's corresponding computing system (e.g., to avoid providing that system with redundant data because that system already has scanning data for the areas it scanned). Accordingly, the service sends to each computing system reduced resolution representation data that was generated from 3D scanning data acquired by a different computing system.

In some embodiments, an HMD is used to scan an environment to generate 3D scanning data of the environment. The HMD transmits the 3D scanning data to a central processing service to enable the service to generate a 3D surface mesh. In turn, the HMD receives reduced resolution representation data, which is generated based on 3D scanning data acquired by one or more other HMDs. Notably, these other HMDs were scanning the environment during the same time period as when the HMD was scanning the environment. The HMD actively refrains from merging its own 3D scanning data with the received reduced resolution representation data. Consequently, the 3D scanning data and the reduced resolution representation data remain distinct from one another. The HMD does, however, align the 3D scanning data with the reduced resolution representation data. The HMD also simultaneously renders a first visualization, which corresponds to the 3D scanning data, with one or more secondary visualization(s), which correspond to the reduced resolution representation data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example scenario in which first responders are responding to an emergency in a building, where the building includes multiple floors and different floor layouts.

FIGS. 2A and 2B illustrate how it is beneficial to coordinate the activities or paths of the first responders so as to more effectively and efficiently clear, sweep, or scan rooms in a building, especially when responding to an emergency.

FIGS. 3A, 3B, 3C, 3D, and 3E illustrate how an environment can be scanned to generate a digital 3D representation of the environment. Each of these figures shows how the depth map and head pose of the first responder captures different perspectives and viewpoints.

FIG. 4A illustrates how multiple devices can generate 3D scanning data and how the 3D scanning data and/or the associated position and pose estimations can be transmitted to a central processing service (e.g., either a central cloud service or a central local service) to enable the central processing service to generate a robust 3D surface mesh of the environment.

FIG. 4B illustrates how the scanning data can include numerous different types and amounts of data describing the environment.

FIG. 5A illustrates how the central processing service is able to provide real-time feedback (e.g., “reduced resolution representation data”) to the scanning devices (e.g., HMDs or other scanning devices, such as a scanning sensor connected to a laptop or tablet that are able to perform data processing and visualization of real-time feedback) to help facilitate or coordinate the scanning activities of those devices to avoid redundant scanning or perhaps even to trigger a re-scan or additional scan of an area in the event the area was not adequately scanned during an initial scan.

FIG. 5B illustrates how the reduced resolution representation data can include numerous different types and amounts of reduced, coarse, skeleton, or limited information describing which areas of an environment have or have not been scanned. The limited information is designed to satisfy different thresholds (e.g., network bandwidth threshold, data limit thresholds, etc.) to enable quick transmission and incorporation/adoption into each HMD.

FIGS. 5C and 5D illustrate other example techniques for providing reduced resolution representation data to other HMDs.

FIG. 6 illustrates an enlarged version of a mini-map indicating where different users/HMDs have been within an environment. In particular, FIG. 6 illustrates a breadcrumb trail or footprint trail for each of the different users/HMDs. In some cases, the breadcrumb trails may overlap, indicating that multiple users/HMDs have crossed the same path.

FIG. 7 illustrates an example scenario in which a bird's eye two-dimensional (“2D”) perspective mini-map is rendered by a user's HMD to inform the user where his/her other companions have already been within the environment. Such a feature is particularly beneficial when scanning or clearing rooms so as to avoid redundant scanning or clearing.

FIG. 8A illustrates an example scenario in which a first responder is determining whether to enter a particular room in an environment.

FIG. 8B illustrates an example scenario in which the first responder peeks his/her HMD inside the room and is able to determine that the room has already been scanned by a different HMD because an informative hologram is projected by the first responder's HMD to inform him/her that another first responder has already visited the room. The hologram is generated using reduced resolution representation data received from the central processing service.

FIG. 8C illustrates an example scenario in which the entirety of the room was not previously scanned (or not scanned to an adequate scanning threshold or degree); thus there are a few areas in the room that are still in need of being scanned in order to provide sufficient 3D scanning data to the central processing service to enable it to generate a robust and accurate 3D surface mesh of the room.

FIG. 8D illustrates an example scenario in which a holographic indicator is displayed on the first responder's HMD to inform him/her that certain areas in the room have not yet been adequately scanned and that those areas should be (re)scanned to provide the central processing service with an adequate amount of 3D scanning data to enable it to generate an accurate and robust 3D surface mesh of the room.

FIG. 8E illustrates an example scenario where an HMD is being used to newly scan or, alternatively, to rescan areas in a room that were either not scanned or that were not previously scanned to an adequate degree or amount.

FIG. 9 illustrates an example scenario in which a first HMD (not shown) has already scanned a room and a second HMD is now approaching the already-scanned room. Here, the second HMD renders multiple different holograms to indicate how the room was already scanned by the first HMD and also to indicate areas where the second HMD is scanning or is being pointed at. In some cases, multiple holograms can overlap one another to indicate that multiple HMDs have scanned the same area or been present at the same area.

FIG. 10A illustrates a flowchart of an example method for receiving real-time feedback (e.g., reduced resolution representation data) from a central processing service so that a receiving HMD can visualize the different paths traveled by any number of other HMDs located within the same environment.

FIG. 10B illustrates a flowchart of an example method for aligning 3D scanning data with reduced resolution representation data to ensure the two sets of data share the same coordinate axis. This alignment process may be performed without fusing, merging, or otherwise joining the two sets of data into a single composite of data (i.e. the data is prevented from being joined or fused together).

FIG. 11 illustrates a flowchart of an example method performed by a central processing service for receiving 3D scanning data from multiple devices and for generating and transmitting reduced resolution representation data back to those devices so they can then visualize the different paths traveled by other devices in the environment.

FIG. 12 illustrates an example computer system capable of performing any of the disclosed operations.

### DETAILED DESCRIPTION

The disclosed embodiments improve the coordination between multiple scanning devices (e.g., HMDs, laptops, tablets, or any scanning device capable of performing depth data processing and visualization of real-time feedback) used to map out an environment.

In some embodiments, a system/device scans an environment to generate 3D scanning data. This data is transmitted to a central processing service to generate a digital 3D representation of the environment. The system receives reduced resolution representation data from the service, where the reduced resolution representation data was generated based on 3D scanning data generated by other systems/devices that were also scanning the environment. The system renders a first visualization, which corresponds to the 3D scanning data, simultaneously with one or more secondary visualization(s), which correspond to the reduced resolution representation data.

In some embodiments, a central processing service provides real-time feedback to multiple systems/devices to enable those systems to visually differentiate between areas in an environment that have or have not been sufficiently scanned/mapped. The service first receives 3D scanning data from the systems, where the received data describes a common environment in which the systems are located. The service uses the 3D scanning data to generate a digital 3D representation of the environment. The service also uses the 3D scanning data to generate multiple sets of reduced resolution representation data, with a corresponding set being generated for each system. Each set describes an area that was scanned up to a scanning threshold by that set's corresponding system. For each set, the service also transmits the set to each computing system except for that set's corresponding system. That is, the service sends to each system reduced resolution representation data based on 3D scanning data generated by another system.

In some embodiments, an HMD scans an environment to generate 3D scanning data. The HMD transmits the 3D scanning data to a central processing service to generate a 3D surface mesh. The HMD receives (e.g., from the central processing service) reduced resolution representation data generated from 3D scanning data acquired by one or more other HMDs and not by the HMD. The HMD actively refrains from merging its 3D scanning data with the reduced resolution representation data. Without merging the two data sets, the HMD aligns the two sets. The HMD also simultaneously renders a first visualization, which corresponds to the 3D scanning data, with one or more secondary visualization(s), which correspond to the reduced resolution representation data.

### Example Technical Benefits, Advantages, and Improvements

The following section outlines some example improvements and practical applications provided by the disclosed embodiments. It will be appreciated, however, these are just examples only and that the embodiments are not limited to only these improvements.

The disclosed embodiments bring about numerous benefits to the technology by coordinating any number of sweeping, scanning, and/or clearing activities performed by multiple systems/devices (e.g., HMDs/MR systems) located within the same environment. By coordinating these activities, the embodiments help prevent redundantly generating scanning data for the same areas and also help to improve the efficiency by which an environment is navigated, cleared, and mapped.

In some cases, the disclosed embodiments also improve the efficiency by which a computer system operates. For example, less computer resources will be used by ensuring that the same environment is not redundantly scanned by multiple different sets of 3D scanning sensors. As a consequence, not only will fewer computer resources be used, but an HMD's battery life will also be prolonged. Furthermore, by eliminating or preventing the generation of redundant data, the hardware used to generate the resulting 3D mesh will operate on a lesser amount of data, and thus its processes will also be made more efficient. These and other benefits/improvements will be discussed in more detail later in connection with some of the other figures provided in this disclosure.

### Navigating, Clearing, and Scanning an Environment

As an initial matter, it should be noted that while many of the examples disclosed herein are related to first responders and emergency scenarios, it will be appreciated that the disclosed embodiments are not limited only to these types of scenarios. Indeed, the principles may be practiced in emergency situations as well as any type of non-emergency situations (e.g., architectural scenarios, construction scenarios, business scenarios, training scenarios, academic scenarios, etc.). Accordingly, the disclosed “emergency” examples are provided for illustrative purposes only and should not be read as limiting the scope of the disclosed principles.

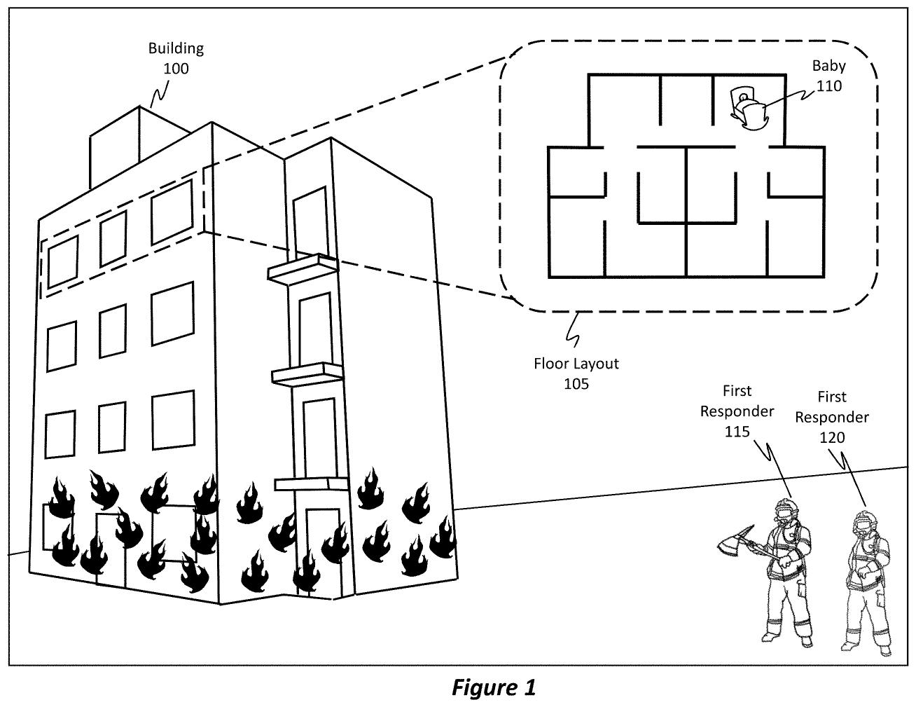

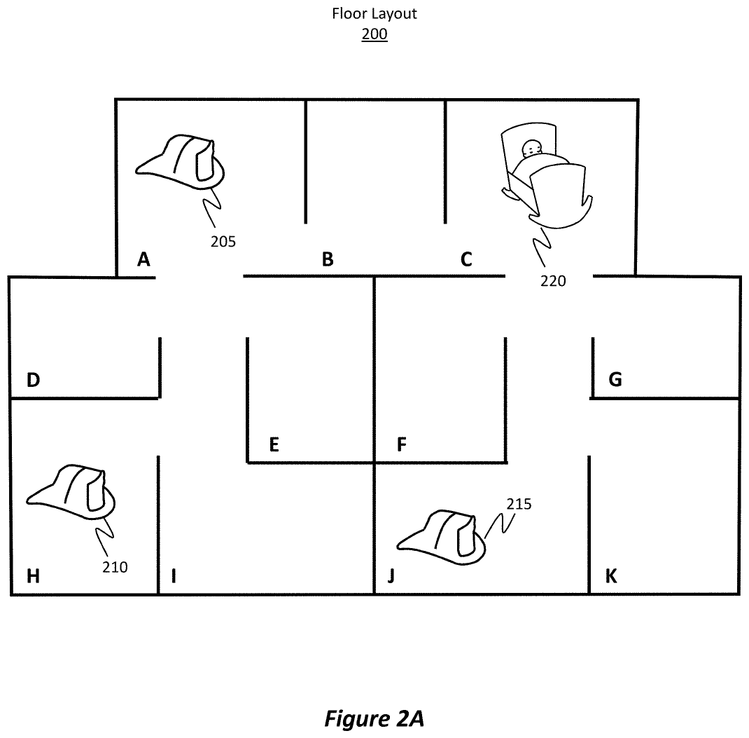

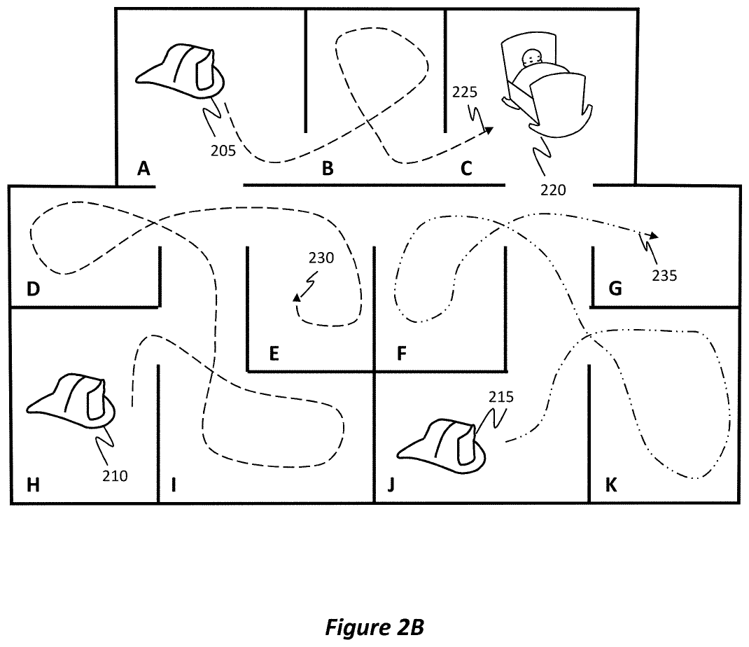

Attention will now be directed to FIG. 2A, which shows an example floor layout 200 similar to that of floor layout 105 from FIG. 1. FIG. 2A shows how different rooms are located within the floor layout 200, such as rooms A, B, C, D, E, F, G, H, I, J, and K.

First responder 205 is located in room A; first responder 210 is located in room H; and first responder 215 is located in room J. Additionally, a baby 220 is located in room C. In an emergency scenario, it is highly desirable for the first responders 205, 210, and 215 to quickly and efficiently clear each of the rooms to ensure that nobody is injured or left behind and also to find the baby 220. Furthermore, in emergency scenarios, it is highly desirable that the first responders 205, 210, and 215 do not redundantly search the same rooms. Such redundancy results in wasted effort by the first responders and may consume an exorbitant amount of time.

FIG. 2B shows an efficient technique for the first responders 205, 210, and 215 to search the floor. Here, first responder 205 clears rooms A, B, and C and discovers the baby 220. The path traveled or navigated by first responder 205 is shown by augmented reality holograms of footprint 225 (or other visual cues).

First responder 210 is shown as clearing rooms D, E, H, and I, as shown by footprint 230. Furthermore, first responder 215 is shown as clearing rooms F, G, J, and K, as shown by footprint 235. Notice, none of the first responders 205, 210, or 215 clear a room that has already been cleared by another first responder. As such, the actions of these first responders show how a highly efficient and non-redundant search pattern was used to clear the floor. As will be described herein, the disclosed embodiments can be used to help coordinate the navigation paths between different users to ensure that those users do not redundantly follow a same or overlapping path when sweeping, clearing, or otherwise mapping/scanning an environment.

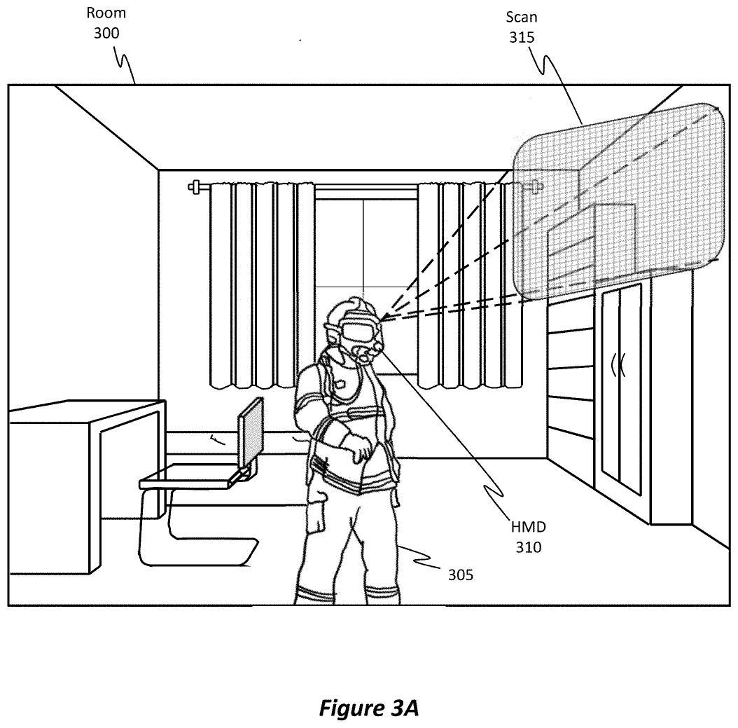

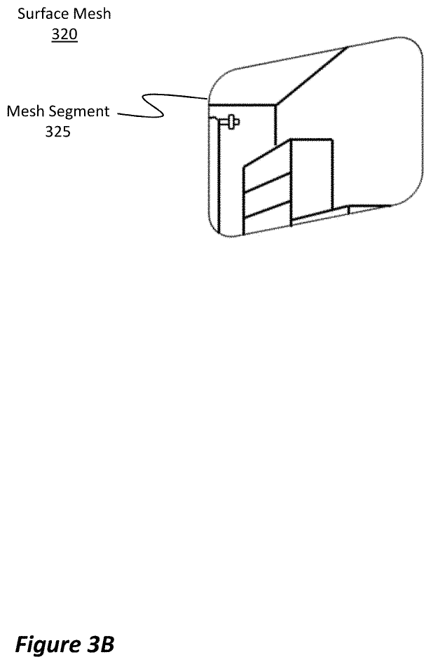

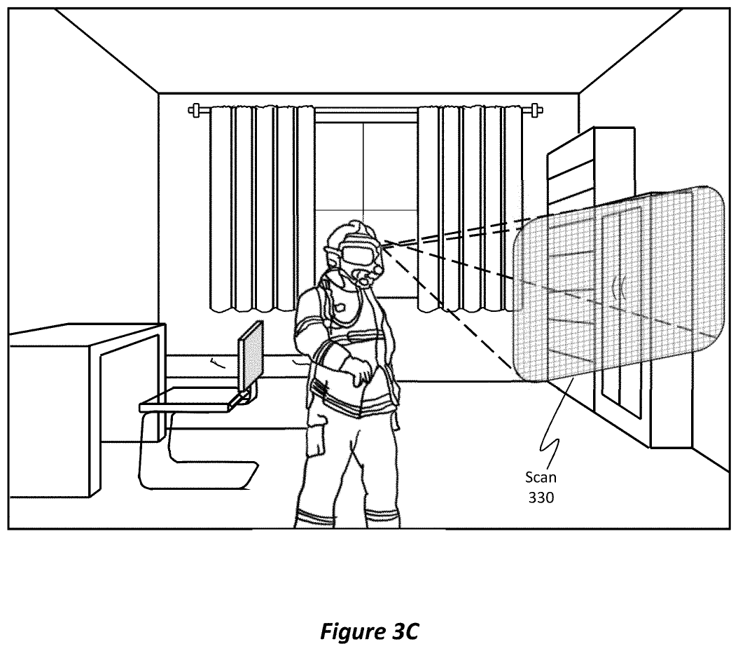

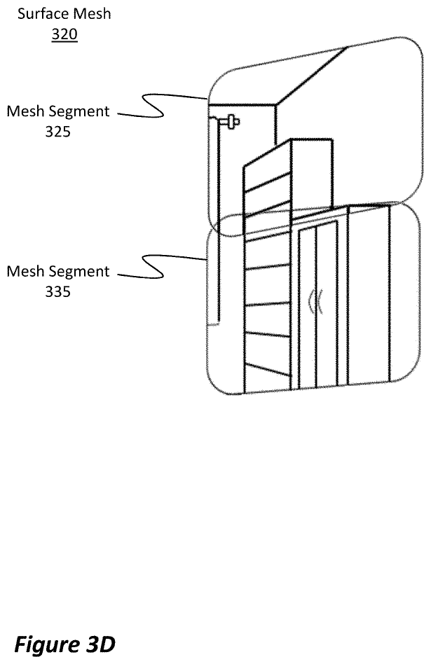

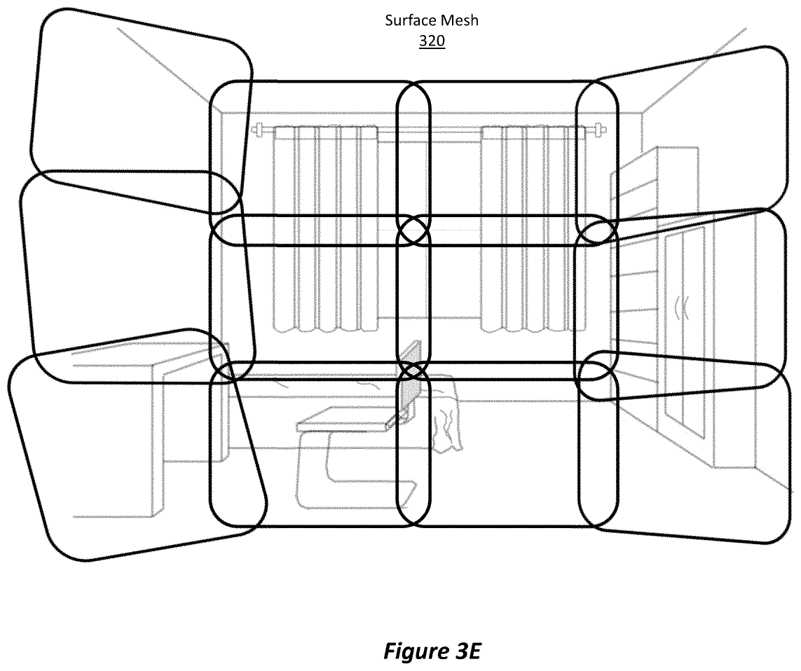

FIG. 3A shows an example scenario in which a room 300 is being cleared and scanned by a user 305 (e.g., perhaps a first responder) wearing an HMD 310, which is being used to perform the scan 315 of the room 300. Room 300 may be an example of any of the rooms shown in FIG. 2B.

HMD 310 includes one or more depth cameras or 3D scanning sensors. As used herein, a “depth camera” (or “3D scanning sensor” or simply “scanning sensor”) includes any type of depth camera or depth detector. Examples include, but are not limited to, time-of-flight (“TOF”) cameras, active stereo camera pairs, passive stereo camera pairs, or any other type of camera, sensor, laser, or device capable of detecting or determining depth. HMD 310's depth cameras are used to acquire 3D scanning data of room 300. This 3D scanning data identifies depth characteristics of room 300 and is used to generate a “3D surface mesh” (or “3D surface reconstruction mesh,” “surface mesh,” or simply “mesh”) of room 300. This surface mesh is used to identify the objects within the environment as well as their depth with respect to one another and possibly with respect to HMD 310.

In an AR environment, an AR system relies on the physical features within the real-world to create virtual images (e.g., holograms). As an example, the AR system can project a dinosaur crashing through the wall of the bedroom or can guide the user 305 in navigating between rooms. For example, perhaps room 300 is smoky from a fire, and visibility is very limited. In this case, the AR system can help the user 305 navigate the room by rendering navigation virtual images telling the user 305 where to go to escape the room. To make the virtual images and experience as realistic and useful as possible, the AR system uses the depth and surface characteristics of the room 300 in order to determine how best to create any virtual images. The surface mesh beneficially provides this valuable information to the AR system. Consequently, it is highly desirable to obtain an accurate surface mesh for any environment, such as room 300.

In a VR environment, the surface mesh also provides many benefits because the VR system can use the surface mesh to help the user avoid crashing into real-world objects (e.g., fixed features or furniture) while interacting with the VR environment. Additionally, or alternatively, a surface mesh can be captured to help a user visualize a 3D space. Consequently, it is highly beneficial to construct a surface mesh of an environment, regardless of what type of MR system is in use.

FIGS. 3A through 3E show an example technique for acquiring the data used to construct the surface mesh. Here, room 300 is a bedroom environment that includes a table, a chair, a closet, a bookcase, and a windowpane with drapes. Currently, HMD 310 is being used to scan room 300 in order to acquire data about those objects as well as other characteristics of room 300.

During this scanning process/phase, HMD 310 uses its one or more depth camera(s) to capture multiple depth images of room 300, as shown by the scan segment 315 (corresponding to a “depth image” for that area of the room). The resulting depth images are used to generate multiple depth maps of room 300. By fusing the information from these different images together, a digital 3D representation of room 300 can be generated.

To illustrate, FIG. 3B shows a surface mesh 320 that initially has a mesh segment 325. Mesh segment 325 corresponds to scan segment 315 from FIG. 3A. In this scenario, because only a single scan segment 315 has been obtained, the surface mesh 320 of room 300 is not yet complete. As HMD 310 further scans room 300, more pieces of the surface mesh 320 will be created.

FIG. 3C shows the same environment, but now HMD 310 is capturing a different viewpoint/perspective of the environment, as shown by scan segment 330. Specifically, scan segment 330 from FIG. 3C is used to further build the surface mesh 320, as shown in FIG. 3D. More specifically, surface mesh 320 in FIG. 3D now includes mesh segment 335, which was generated based on the information included in scan segment 330, and surface mesh 320 also includes mesh segment 325, which was added earlier. In this regard, multiple different depth images are obtained, acquired, or generated and are used to progressively build surface mesh 320 for room 300. The information in the depth images is fused together to generate a complete surface mesh 320 and to determine the depths of objects within room 300, as shown by FIG. 3E.

To obtain these depth images, HMD 310 performs a “scanning phase” by capturing depth images at different locations, perspectives, or viewpoints. This so-called “scanning phase” is typically performed rather quickly (e.g., under a minute), but its duration may be dependent on the size of the room or environment (i.e. larger rooms/environments may take longer than smaller rooms/environments). In some embodiments, a low resolution surface mesh can also be built in real-time by the scanning device. As will be discussed later, however, building the high resolution, high quality surface mesh may take considerable time (e.g., minutes or perhaps even hours). As the surface mesh 320 is created, it can be stored in a repository for future use or reference. In some cases, the surface mesh 320 is stored in the cloud and can be made available for any number of devices. Consequently, some embodiments query the cloud to determine whether a surface mesh is already available for an environment prior to scanning the environment.

Surface mesh 320 can also be used to segment or classify objects within room 320. For instance, the objects captured by surface mesh 320 can be classified, segmented, or otherwise characterized. This segmentation process is performed, at least in part, by determining the attributes of those objects. In some cases, this segmentation process can be performed via any type of machine learning (e.g., machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system).

Specifically, surface mesh 320 can be used to segment or identify the closet, the bookcase, the windowpane with drapes, the desk, the chair, the bed, and so on in room 300. Any number of objects, including their respective object types, may be identified via the surface mesh 320.

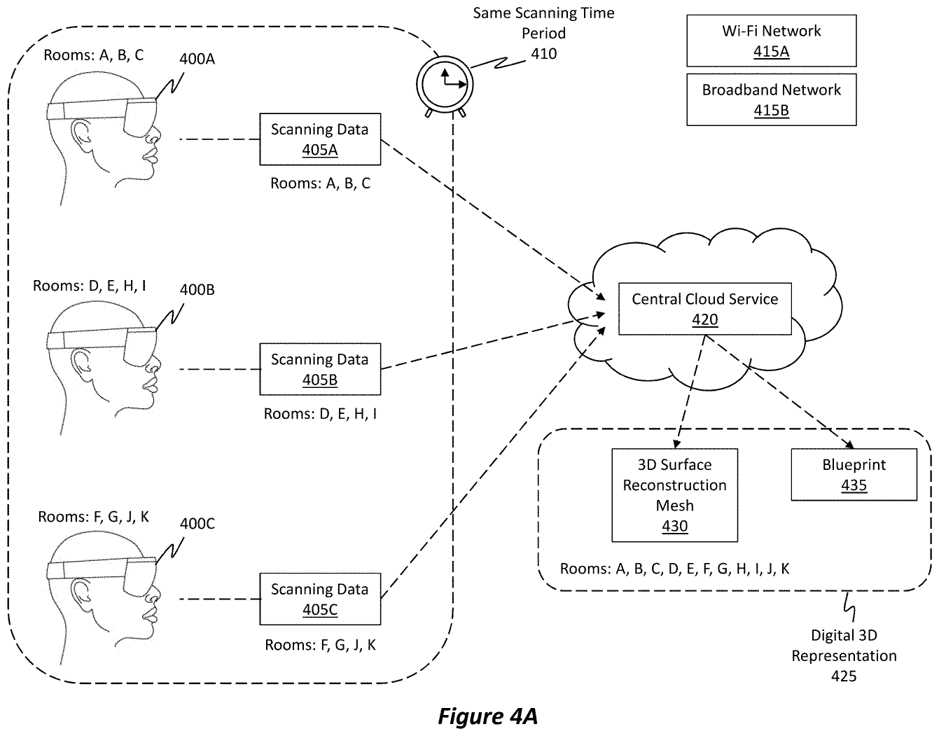

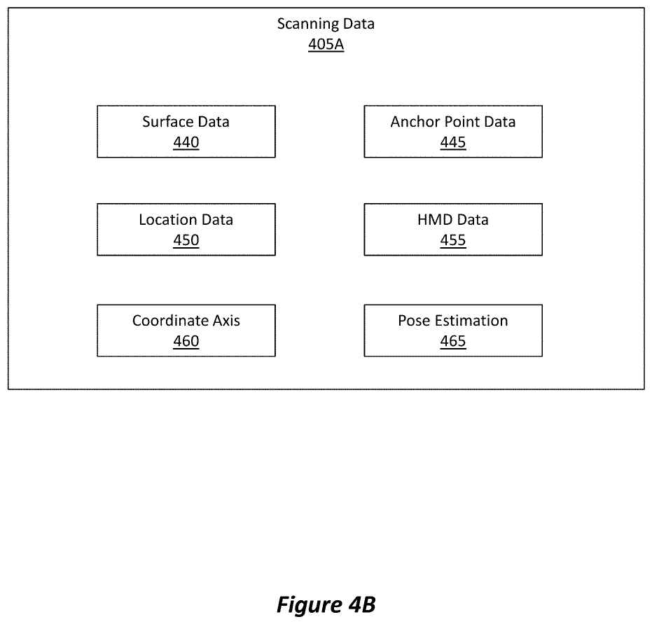

FIG. 4A more fully elaborates how 3D scanning data can be used to generate a digital 3D representation of an environment, such as room 300 from FIG. 3 or even the entire building 100 from FIG. 1. As used herein, the phrase “digital 3D representation” should be interpreted broadly to include any kind of digital representation of an environment. For example, the digital 3D representation may include a 3D surface mesh (aka 3D surface reconstruction mesh), a 3D point cloud, a depth map, or any other type of digital representation that identifies the different geometries, shapes, depths, and contours of an environment.

FIG. 4A shows three HMDs, namely HMD 400A, HMD 400B, and HMD 400C. The users wearing these HMDs may be representative of the first responders 205, 210, and 215 from FIG. 2A.

FIG. 4A shows how HMD 400A has generated or acquired 3D scanning data 405A for rooms A, B, and C using HMD 400A's corresponding scanning sensors. With reference to FIG. 2B, it was shown how first responder 205 navigated rooms A, B, and C. During these navigations, first responder 205's HMD acquired scanning data 405A, in the manner described in connection with FIGS. 3A-3E.

Similarly, the user wearing HMD 400B navigated rooms D, E, H, and I and HMD 400B generated or acquired scanning data 405B using its corresponding scanning sensors. The user wearing HMD 400C navigated rooms F, G, J, and K, and HMD 400C generated or acquired scanning data 405C using its scanning sensors.

Turning briefly to FIG. 4B, scanning data 405A from FIG. 4A can include numerous different types and amounts of data, as shown in FIG. 4B. Of course, scanning data 405B and 405C may include similar data as well.

As shown in FIG. 4B, scanning data 405A can include surface data 440 (i.e. depth data describing the geometries, shapes, depths, and contours of objects, surfaces, or other features of an environment). Scanning data 405A can also include anchor point data 445. Anchor point data 445 describes any number of anchor points that are identified within an environment. An anchor point is a location, feature, or set of fiduciary points within an environment that is determined to have a sufficiently low likelihood of moving (i.e. it is determined to have highly static characteristics satisfying a static threshold requirement). To identify anchor points, the points or locations in the environment can be put through an initial segmentation process to determine their characteristics. Based on these characteristics, the HMD can determine whether a point, location, or object is likely to be dynamic (i.e. it probably will move) or static (i.e. it probably will not move).

Anchor points represent locations within an environment that are highly static (i.e. the characteristics of those locations satisfy a static threshold). By way of example, the corners of the dresser in FIG. 3A may be highly static/non-moving and may serve as an anchor point. Likewise, the corners of the room may serve as worthwhile anchor points because walls typically do not shift. In contrast, the chair or window drapes are probably not very static and would not serve well as anchor points.

Scanning data 405A may also include location data 450, such as GPS coordinate data, triangulation data from a telecommunications network, triangulation data from wireless routers, or perhaps signal strength data (indicating proximity) relative to a router or other sensing device.

Additionally, scanning data 405A may include any other type of HMD data 455, such as the amount of time used to scan a particular area, whether the area was fully scanned or only partially scanned, the identification information for the HMD used to scan the area, the timing or timestamp of when the area was scanned, which hardware scanners were used to perform the scan, or perhaps even a quality or accuracy metric detailing the quality of the scan. The scanning data 405A may also include coordinate axis 460 data to determine the orientation of the room relative to a known vector, such as gravity or some other determined reference point (e.g., the orientation of the vertical wall corners in the room). Additionally, the scanning data 405A may include pose estimation 465 data describing one or more poses of the HMD. As used herein, “pose” generally refers to the angle and direction in which the HMD is being aimed or pointed (i.e. a “viewing vector”). The HMD is able to determine its pose and transmit any number of poses via the pose estimation 465 data.

While the above examples are primarily directed towards indoor activities, it should be noted that the disclosed principles can also be practiced in outdoor environments as well. As such, the disclosed principles should be interpreted broadly to include or to be usable in any type of environment, both indoor and outdoor.

Returning to FIG. 4A, HMDs 400A, 400B, and 400C were traveling through the same environment (which included multiple rooms as shown by floor layout 200 of FIG. 2A) during the same time period, as shown by same scanning time period 410. It will be appreciated that the same scanning time period 410 can be any duration or length of time.

For instance, the same scanning time period 410 can include a range of time spanning a few seconds, minutes, hours, or perhaps even days. In some scenarios, HMDs 400A, 400B, and 400C are scanning the environment during the same overlapping time while in other scenarios HMDs 400A, 400B, and 400C are scanning the environment at different times but still within the same scanning time period 410.

As an example, suppose the same scanning time period 410 was 15 minutes. In this specific example, HMD 400A scans the environment only during the first five minutes of the fifteen-minute block. HMD 400B then scans the environment only during the second five-minute block. HMD 400C then scans the environment only during the third five-minute block. In this regard, HMDs 400A, 400B, and 400C all scanned the environment within the same scanning time period 410 even though their individual scanning durations did not overlap. Of course, that is one example scenario, and it will be appreciated that one or more scans can overlap in time/duration with one or more other scans.

FIG. 4A also shows how HMDs 400A, 400B, and 400C are able to transmit their respective scanning data to a central cloud service 420, which is one example of a “central processing service” and which represents a “spatial reconstruction as a service” (SRaaS). More particularly, HMD 400A transmits scanning data 405A to central cloud service 420; HMD 400B transmits scanning data 405B to central cloud service 420; and HMD 400C transmits scanning data 405C to central cloud service 420. Here, central cloud service 420 is a computing service operating in a cloud network and is available to HMDs and users on-demand via the Internet by a cloud service provider.

The HMDs 400A-C can transmit their respective data sets to the central cloud service 420 in numerous different ways or through numerous different communication networks and protocols. As one example, the HMDs 400A-C can rely on a Wi-Fi network 415A to transmit their data. Additionally, or alternatively, the HMDs 400A-C can rely on a separate broadband network 415B to transmit their data. Examples of broadband network 415B include, but are not limited to, a telecommunications network, an inter-squad radio network (encrypted or not encrypted), and possibly a Bluetooth network.

If the HMDs 400A-C are located inside of a building (e.g., perhaps building 100 of FIG. 1), then the HMDs 400A-C can connect to a wireless hub or router of the building's Wi-Fi network to transmit their data. Combinations of the above networks may be used as well. For instance, one HMD may use a Wi-Fi network while another HMD uses a telecommunications network.

Central cloud service 420 receives the scanning data from the multiple different HMDs. Using this scanning data, central cloud service 420 begins generating a digital 3D representation 425 of the environment, where the environment is a combination of rooms A, B, C, D, E, F, G, H, I, J, and K. In some embodiments, the digital 3D representation 425 is or includes a 3D surface reconstruction mesh 430 of those rooms. In some embodiments, the digital 3D representation 425 includes a 3D point cloud, or any type or number of depth maps of those rooms. The central cloud service 420 need not wait until all of the scanning data is received prior to commencing the build of the digital 3D representation 425. Instead, the central cloud service 420 can progressively build the digital 3D representation 425 as new scanning data is progressively received.

Additionally, central cloud service 420 can use the scanning data to generate a blueprint 435 of the rooms, where the blueprint 435 can be included as a part of the digital 3D representation 425 and where the blueprint 435 is generated using the 3D scanning data. Here, central cloud service 420 can generate a 2D blueprint outlining the different rooms (e.g., rooms A through K) relative to one another, as shown by floor layout 200 of FIG. 2. This blueprint 435 can be created for each floor of a building and, therefore, a blueprint can be provided for the entire building. Accordingly, the disclosed embodiments are able to dynamically generate a 2D blueprint for a building based on the scanning data. Additionally, the disclosed embodiments are able to generate a 3D representation of the building based on the scanning data.

The process of fully computing the high quality, high resolution digital 3D representation 425 often takes a prolonged period of time, sometimes spanning many minutes or even hours. The digital 3D representation 425 may take longer to compute for more complex environments (i.e. meaning there is more complex scanning data to compute) than for less complex environments.

Reduced Resolution Representation Data

As described earlier, it is highly desirable to coordinate the activities of multiple users or HMDs engaged in navigating an environment. In some cases, these navigations are performed to clear rooms of the environment to check for victims in an emergency event/condition while in other cases these navigations are performed simply to map out the environment without facing an emergency event/condition. Regardless of the purpose for which the users and HMDs are navigating the rooms, it is highly desirable to be able to quickly and accurately coordinate the users' and HMDs' navigation paths so that the users and HMDs can navigate the environment quickly and efficiently and without redundantly scanning or clearing the same room multiple times by multiple different users/HMDs. Unfortunately, it is highly expensive, both in terms of compute and bandwidth, to pass 3D scanning data quickly from HMD to HMD. What is needed, therefore, is an improved technique for informing HMDs regarding the locations of other HMDs in the same environment and to do so without passing full 3D scanning data among the different HMDs.

With that understanding, the disclosed embodiments can be used to provide the desired coordination between the multiple different HMDs while refraining from passing full 3D scanning data amongst themselves. For instance, with regard to FIG. 2B, the embodiments can intelligently inform first responder 205 (e.g., via an HMD) that he/she does not need to clear rooms D, E, F, G, H, I, J, and K because first responders 210 and 215 have already done so. Similarly, the embodiments can intelligently inform first responder 210 that he/she does not need to clear rooms A, B, C, F, G, J, and K because first responders 205 and 215 have already done so. To complete the example, the embodiments can also intelligently inform first responder 215 that he/she does not need to clear rooms A, B, C, D, E, H, and I because first responders 205 and 210 have already done so. In some cases, additional instructions can be provided by a central guiding person, operator, or entity tasked with informing the users where they should or should not go (e.g., perhaps via voice commands or a displayed chat thread). To perform these processes, the embodiments make use of what is referred to as “reduced resolution representation data” to make these intelligent guiding instructions.

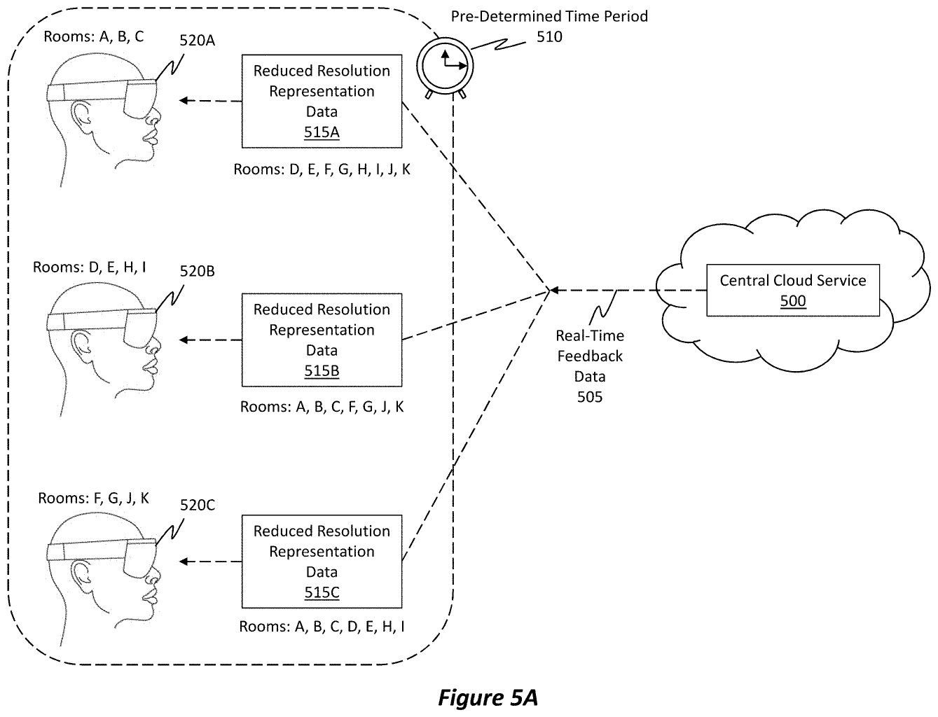

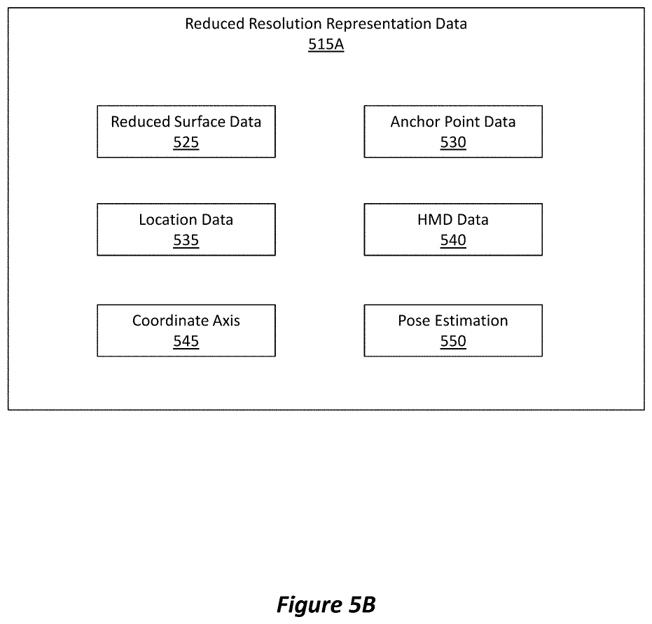

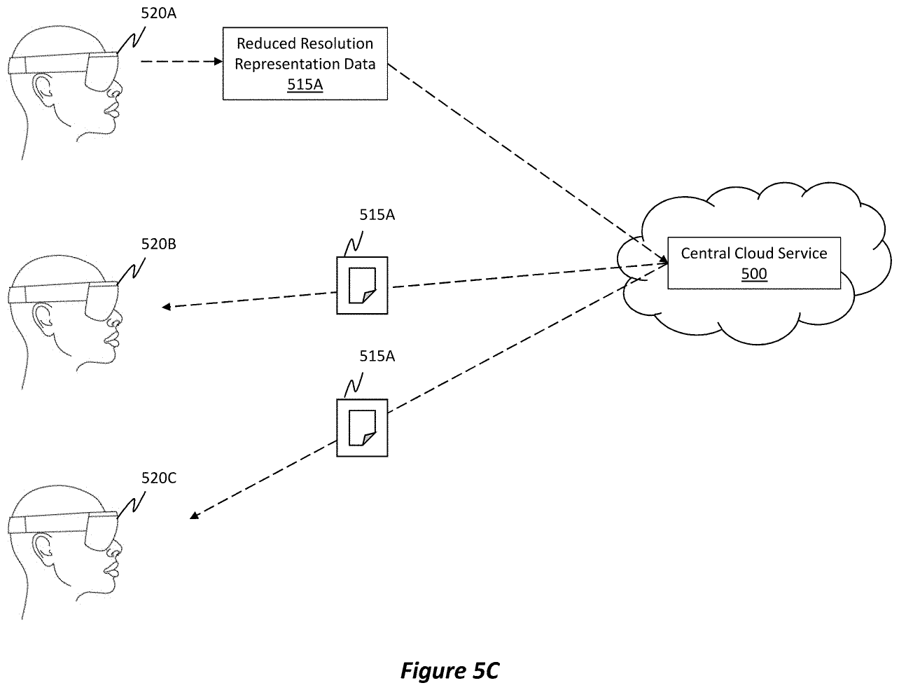

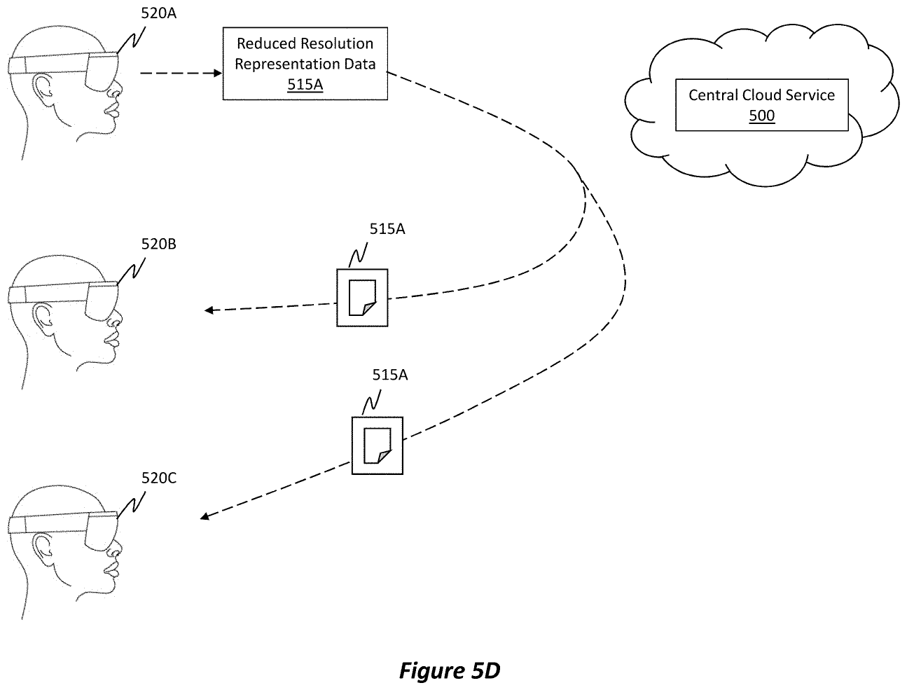

FIG. 5A shows an example scenario in which reduced resolution representation data (i.e. coarse, skeleton, or limited data, as will be described later) is being used to inform multiple HMDs regarding which areas of an environment have or have not already been scanned to a sufficient scanning threshold. In particular, FIG. 5A shows a central cloud service 500, which is representative of the central cloud service 420 from FIG. 4A.

Central cloud service 500 is providing real-time feedback data 505 to a group of multiple HMDs to inform those HMDs of the areas that have already been scanned and/or navigated by other HMDs. The real-time feedback data 505 is provided to the HMDs within a pre-determined time period 510 subsequent to when the scanning data (e.g., scanning data 405A, 405B, and 405C from FIG. 4A) was received by the central cloud service 500.

This pre-determined time period 510 may be set to any period of time. Example time periods include, but are not limited to, 0.25 seconds, 0.5, 0.75, 1, 2, 3, 4, 5, 10, 30, or 60 seconds after the central cloud service 500 receives scanning data from the HMDs. The real-time feedback data 505 can be provided to the HMDs within the pre-determined time period 510 in response to new scanning data being received at the central cloud service 500. To clarify, the event of receiving new scanning data from any one or more HMDs can operate as a triggering mechanism to trigger the central cloud service 500 to provide updated or new real-time feedback data to the HMDs. Accordingly, as the central cloud service 500 progressively receives new scanning data from the HMDs, the central cloud service 500 in turn progressively provides new real-time feedback data back to the HMDs.

In some scenarios, the pre-determined time period 510 may be over 1 minute after the central cloud service 500 receives new scanning data while in other scenarios the pre-determined time period 510 may be less than 1 second after the central cloud service 500 receives new scanning data. Typically, shorter time periods (e.g., less than 10 seconds) are preferred over longer time periods (e.g., over 10 seconds). In any event, the pre-determined time period 510 may be set to any time length and is not limited to any specific length of time. The duration of the pre-determined time period 510 may be dependent on the quantity of new scanning data received from the HMDs. Additionally, or alternatively, the duration may be dependent on communication bandwidth constraints, network availability constraints, or even settings published by the HMDs themselves (e.g., the HMDs may publish settings to the central cloud service 500 to indicate that the HMDs desire to receive updated real-time feedback data only periodically at certain time intervals as opposed to receiving feedback each time the HMD provides new scanning data).

The real-time feedback data 505 includes different information for different receiving HMDs. For instance, real-time feedback data 505 includes reduced resolution representation data 515A, 515B, and 515C.

Reduced resolution representation data 515A is being transmitted to HMD 520A; reduced resolution representation data 515B is being transmitted to HMD 520B; and reduced resolution representation data 515C is being transmitted to HMD 520C. From the perspectives of the HMDs, therefore, reduced resolution representation data can be received from a central processing service (e.g., the central cloud service 500) within a pre-determined time period 510 subsequent to when any one or more of the HMDs provides updated scanning data to the central processing service. Because the reduced resolution representation data is provided within the time constraints indicated by the pre-determined time period 510, the reduced resolution representation data constitutes “real-time” feedback data.

Turning briefly to FIG. 5B, this figure illustrates some of the data that may be included in reduced resolution representation data 515A, as well as the reduced resolution representation data 515B and 515C. In particular, the reduced resolution representation data 515A may include some reduced surface data 525, anchor point data 530, location data 535, HMD data 540, coordinate axis 545 data, and/or pose estimation 550 data.

Reduced surface data 525 may include highly simplified, coarse, skeleton, or limited data describing an area at a very high level without particular details regarding specific features located in the area. For instance, in some cases, the reduced surface data 525 may include only a binary indication (and no 3D data) indicating whether or not the area was previously scanned by a different HMD.

In some cases, reduced surface data 525 includes some reduced, minimal, or basic surface reconstruction data describing the area three-dimensionally. Examples of this minimal data may include data describing only the bounding walls or contours of the area (e.g., the walls of a room) without any data describing features or objects located within the room. For instance, with reference to FIG. 3A, the reduced surface data 525 may include only surface data outlining the locations of the walls and may refrain from including data describing the drapes, windows, dressers, desks, chairs, and so on.

Whereas the 3D scanning data and/or the 3D surface mesh may include a complex array of triangles or other polygons used to describe an environment three-dimensionally, the reduced surface data 525 may include only a limited amount of the triangles or polygons used in the more complex 3D scanning data or 3D surface mesh. For instance, as used herein, a “3D surface mesh,” “surface mesh,” or simply “mesh” is a geometric representation or model made up of any number of discrete interconnected faces (e.g., triangles) and/or other interconnected vertices. The combination of these vertices describes the environment's geometric contours, shapes, and depths, including the contours of any objects within that environment. By generating such a mesh, the embodiments are able to map out the contents of an environment and accurately identify the objects within the environment.

In some embodiments, reduced surface data 525 includes a fraction or percentage of data that was originally provided to the central cloud service in the scanning data. To clarify, the sets of reduced resolution representation data are generated based on the 3D scanning data generated by the HMDs, and each set of reduced resolution representation data may include only a fraction or percentage of data that was originally included in the 3D scanning data. As a consequence, each set of reduced resolution representation data can describe the environment only to a partial extent as opposed to a full extent.

By way of example, suppose scanning data 405A includes a substantial amount of scanning data describing a room (e.g., 10 GB of data). As compared to the amount of data provided by scanning data 405A, the reduced surface data 525 may include only 0.1%, 0.2% 0.25%, 0.5%, 0.75%, 1.0%, 2.0%, 3.0%, 4.0%, or perhaps 5.0% of the amount of surface reconstruction data included in the scanning data 405A (e.g., resulting in 0.01 GB, 0.02 GB, 0.025 GB, 0.05 GB, 0.075 GB and so on). In some circumstances, the percentage may (though rarely) go up to 10%, 20%, 30%, 40%, or perhaps even 50%. In some embodiments, the amount of data in the reduced surface data 525 is capped or limited to a certain number of Megabytes (e.g., 100 MB, 200 MB, 300 MB, 400 MB, 500 MB, and so on) or some other ceiling or threshold value.

In some embodiments, the amount of data included in the reduced surface data 525 (or the amount of data included in the reduced resolution representation data 515A) is limited or otherwise throttled so as to not exceed a determined amount of bandwidth consumption or bandwidth threshold value. For instance, the amount of data may be limited to a determined number of Megabytes Per Second (Mbps). For instance, the threshold value (i.e. the bandwidth threshold) may be limited to 50 Mbps, 60 Mbps, 70 Mbps, 80 Mbps, 90 Mbps, 100 Mbps, 200 Mbps, 300 Mbps, 400 Mbps, 500 Mbps, 600 Mbps, 700 Mbps, 800 Mbps, 900 Mbps, or even 1,000 Mbps. In some embodiments the threshold may be set to lower than 50 Mbps, or it may be set to higher than 1,000 Mbps. In any event, some embodiments selectively limit or reduce the amount of data included within the reduced resolution representation data 515A so as to not exceed a predetermined bandwidth constraint or threshold.

The anchor point data 530, location data 535, HMD data 540, coordinate axis 545 data, and pose estimation 550 data may include similar types of data as the anchor point data 445, location data 450, HMD data 455, coordinate axis 460 data, and pose estimation 465 data, respectively, shown in FIG. 4B. In some cases, the amount of these types of data may also be reduced or throttled to some fraction or percentage relative to the data in FIG. 4B. Similarly, these data amounts may be limited to not exceed a bandwidth constraint as well.

Returning to FIG. 5A, reduced resolution representation data 515A includes data describing the rooms navigated by HMDs 520B and 520C but it does not include data describing the rooms navigated by HMD 520A because such data would be redundant (e.g., HMD 520A was the HMD that originally scanned rooms A, B, and C, so HMD 520A does not need reduced resolution representation data corresponding to those rooms). To clarify, reduced resolution representation data 515A includes data describing only rooms D, E, F, G, H, I, J, and K; it does not include data describing rooms A, B, and C.

Furthermore, HMD 520A actively refrains from merging, fusing, or otherwise joining reduced resolution representation data 515A with its own 3D scanning data (e.g., scanning data 405A from FIG. 4A). In this manner, the two data sets remain distinct from one another. Refraining from merging the data sets (or preventing a merge) is beneficial because it causes less computations to be performed and it also allows for the HMD to clearly distinguish which data was generated by which HMD. Using simplified data as opposed to more complex data (which would be generated if the two data sets were fused together) also allows the HMD to more easily display certain visualizations (as will be described in more detail later) and also allows updates to the data to be performed more quickly with fewer computations.

Similarly, reduced resolution representation data 515B includes data describing only rooms A, B, C, F, G, J, and K; it does not include data describing rooms D, E, H, and I because such data would be redundant (i.e. HMD 520B was the system that scanned those rooms, so it is unnecessary for the central cloud service 500 to provide reduced resolution representation data for those rooms to that HMD). To complete the example, reduced resolution representation data 515C includes data describing only rooms A, B, C, D, E, H, and I, but it does not include data describing rooms F, G, J, and K. In this manner, each HMD/MR system receives reduced resolution representation data corresponding to areas within that environment that were scanned by other HMDs/MR systems. It is not necessary to provide reduced resolution representation data for areas that each HMD itself scanned. Thus, the central cloud service 500 selectively filters (e.g., in the manner described above) the data it provides to each respective HMD so as to prevent or refrain from sending redundant or repetitive data back to each respective HMD.

While FIG. 5A showed one example scenario in which central cloud service 500 provided the reduced resolution representation data to the different HMDs. FIG. 5C, on the other hand, shows a different scenario.

In FIG. 5C, HMD 520A itself generates reduced resolution representation data 515A based off of its own 3D scanning data (e.g., by selectively removing or filtering portions of its data to achieve a determined reduced data amount) and then passes or transmits the reduced resolution representation data 515A to the central cloud service 500 for subsequent distribution to the other HMDs 520B and 520C. Therefore, instead of the central cloud service 500 generating the reduced resolution representation data 515A, some embodiments enable each HMD to generate reduced resolution representation data.

FIG. 5D shows yet another example scenario. Similar to FIG. 5C, HMD 520A has generated reduced resolution representation data 515A based off of its own 3D scanning data. Here, however, instead of transmitting the reduced resolution representation data 515A to central cloud service 500, HMD 520A is transmitting or distributing reduced resolution representation data 515A to the other HMDs 520B and 520C without passing it first through the intermediary central cloud service 500.

Transmitting reduced resolution representation data from one HMD to another HMD can be performed using any type of wireless network. In some cases, the wireless network includes any one or more of the following types of networks: an inter-squad radio network (i.e. a secure multi-link or multi-way radio communications network), a near field communication network, a Bluetooth network, a Wi-Fi network, or even via a telecommunications link. In this regard, some embodiments are able to bypass use of the central cloud service 500 when transmitting and/or receiving reduced resolution representation data. Accordingly, the process of transmitting or receiving data, including the 3D scanning data or the reduced resolution representation data, from or to an HMD or central processing service, may be performed using at least one of the above mentioned wireless networks (e.g., a wireless fidelity (Wi-Fi) network via one or more router(s), a different wireless or wired broadband network, a radio network, etc.).

### Example Visualizations of Reduced Resolution Representation Data

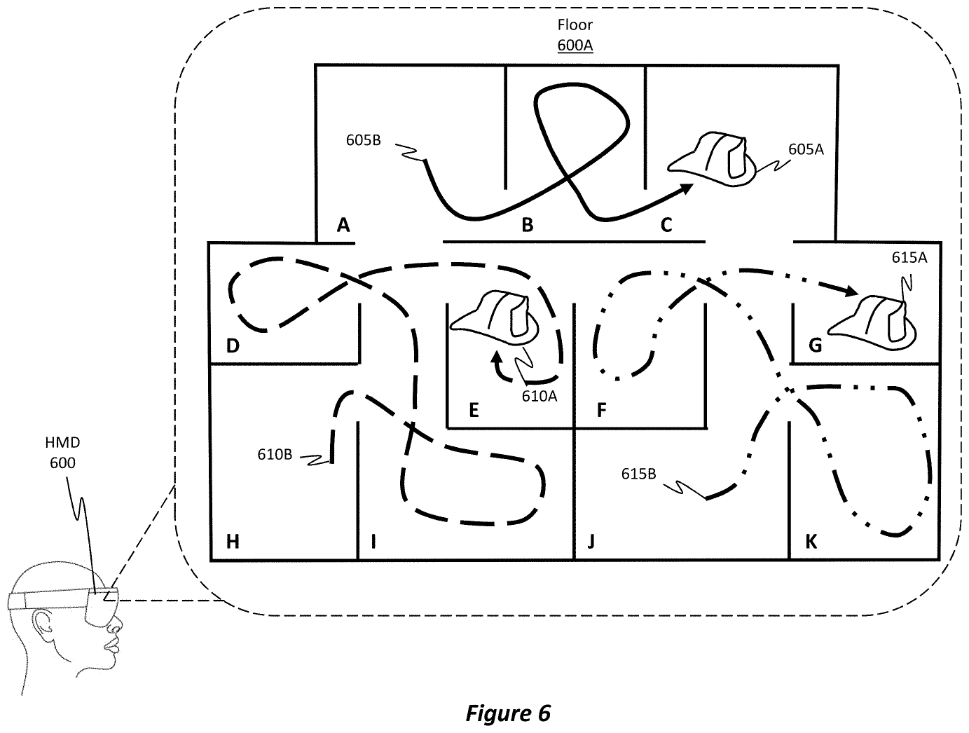

Attention will now be directed to FIG. 6, which provides an example illustration of the virtual image content that can be projected onto a user's HMD to inform the user regarding which areas of an environment have already been navigated to and/or scanned by a separate HMD. In particular, FIG. 6 shows an HMD 600, which may be representative of the HMDs and MR systems discussed thus far. In accordance with the disclosed principles, HMD 600 has received (e.g., from a central processing service or perhaps from another HMD) reduced resolution representation data detailing which areas in the floor 600A have been navigated to by the other HMDs.

For instance, icon 605A is a virtual image representative of the user wearing HMD 600 while icons 610A and 615A are virtual images representative of other users wearing other HMDs. Path 605B represents the route traveled by HMD 600 as HMD 600 navigated through the floor 600A. As shown, path 605B starts in room A, then goes to room B, and ends in room C. In this regard, path 605B visually illustrates the locations where HMD 600 has been while traveling through floor 600A.

Similarly, the HMD (and user) corresponding to icon 610A followed, or rather created, path 610B, which started off in room H, then went to rooms I, D, and E in that order. The HMD (and user) corresponding to icon 615A followed path 615B, which started off in room J, then went to rooms K, F, and G in that order.

HMD 600 is able to display a first visualization corresponding to its own traveled path (e.g., based off of its own 3D scanning data) and one or more secondary visualization(s) corresponding to the traveled paths of the other HMDs (e.g., based off of the received reduced resolution representation data) in its display for the user to view. By rendering this information, users can know which rooms of floor 600A have or have not already been visited and/or scanned. As such, the users' travels through the rooms (whether they are trying to clear the rooms or whether they are simply trying to map out floor 600A) can be coordinated so that each room is not redundantly scanned by multiple HMDs.

Different embodiments are able to display different information in the HMDs. For instance, in some embodiments, the blueprint or layout of floor 600A may not be available or may not yet be generated. As such, the boundaries corresponding to the different walls may not be rendered by the HMD. In some embodiments, the boundaries can be progressively rendered as the HMDs progressively scan floor 600A. In some embodiments, the HMDs are able to initially acquire an existing blueprint of the floor 600A and use that blueprint as an initial reference to then fill in the paths based on the initial reference.

In some implementations, paths 605B, 610B, and 615B can be displayed in different formats. These different formats can be dependent on user/HMD and can include different colors, different line widths, or even different line types (e.g., solid, dashed, dot dash dash, etc.). As will be described later, the embodiments may also include 3D objects rendered in the scene, such as “bread crumbs” showing a user's location. That is, 3D holographic breadcrumbs can be visually rendered in an MR scene.

Some other formatting can include blinking or flashing lines or even actual footprints or tire tracks following a path. The different formatting is provided to assist users in readily determining which path corresponds to which user. In some embodiments, a text label, picture avatar, or some other indicator may be visually rendered proximate to each path to indicate which path belongs to which user. For instance, icon 605A can be the hat for a particular first responder while icon 610A may be the hat for a different first responder. The hats (e.g., examples of indicators) can vary so as to easily distinguish between users. Pictures of the users' faces can also be displayed (e.g., in place of the hats).

While FIG. 6 provides a completed view of the paths of the different users, it will be appreciated that these paths can be continuously updated or filled in as the users navigate to different rooms. As such, each HMD can be periodically or continuously provided with updated reduced resolution representation data in order to determine where the other users are and where they have been. In this regard, FIG. 6 shows how a breadcrumb trail or a footprint path can be visualized on each HMD to enable the user of each respective HMD to identify which areas of the environment have already been navigated to and/or scanned by the HMD's scanning sensors. Such information greatly facilitates efficient navigation and coordination between the different HMDs.

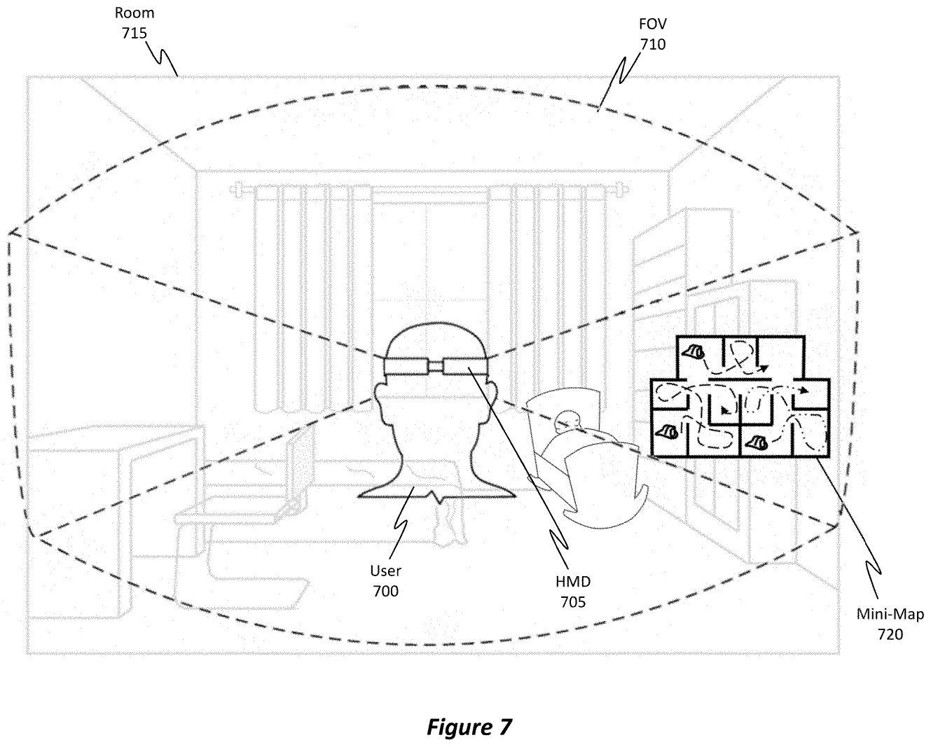

FIG. 7 shows an example illustration of how the paths (e.g., paths 605B, 610B, and 615B from FIG. 6) can be rendered on a user's HMD, which has received reduced resolution representation data describing the locations where other HMDs have already visited as well as the locations where that particular HMD has already visited. Here, there is a user 700 wearing an HMD 705, which has a field of view (“FOV”) 710 (i.e. the observable area the user 700 can view while wearing the HMD 705). User 700 is entering room 715, which corresponds to room C shown in FIG. 2A (i.e. the room with the baby).

Within the FOV 710, HMD 705 is able to render a mini-map 720, which is representative of the visualizations shown in FIG. 6. As shown, mini-map 720 displays not only the user 700's footprint/breadcrumb path, but it also shows the paths of two other users who are also on the same floor as user 700. User 700 can now spend time clearing/scanning room 715 with the knowledge that his/her efforts are not redundant because HMD 705 is providing a clear indication, cue, or clue that room 715 has not been previously cleared/scanned.

Accordingly, in some embodiments, a breadcrumb or footprint path can be visually displayed on a user's HMD. These types of visualizations can be considered to be “wire frame” visualizations in which very simplified data is presented to a user. In some cases, only the wire frame visualizations representing the paths are rendered, and the floor layout is not rendered. In other embodiments, the floor layout is rendered or is progressively rendered as additional 3D scanning data is acquired. As used herein, the phrase “wire frame” should be interpreted broadly to include both two-dimensional visualizations as well as three-dimensional visualizations. For example, in addition to the above descriptions, “wire frame” can also include a visualization of 3D edges of a triangular surface mesh. Accordingly, unless specifically called out, “wire frame” includes both 2D wire frame visualizations as well as 3D wire frame visualizations.

While FIGS. 6 and 7 showed lines/wire frames corresponding to the traveled paths, some embodiments simply fill in an entire room (or if a room is not delineated, then an area is filled in) on the mini-map with a particular color corresponding to a specific user. For instance, rooms A, B, and C (or areas corresponding to those rooms) can be entirely filled in with a particular color, shading, or color gradient to indicate that an HMD has already scanned those rooms.

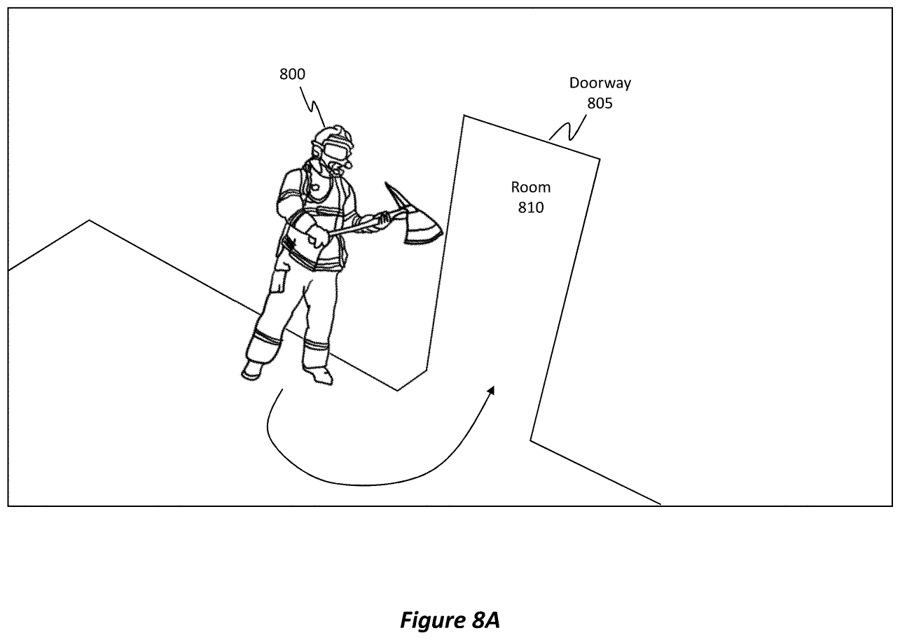

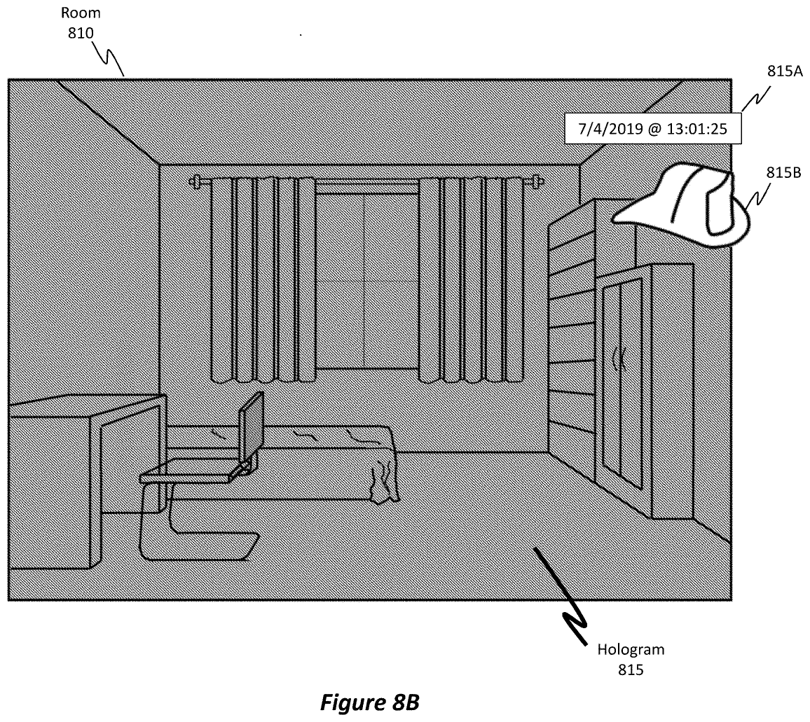

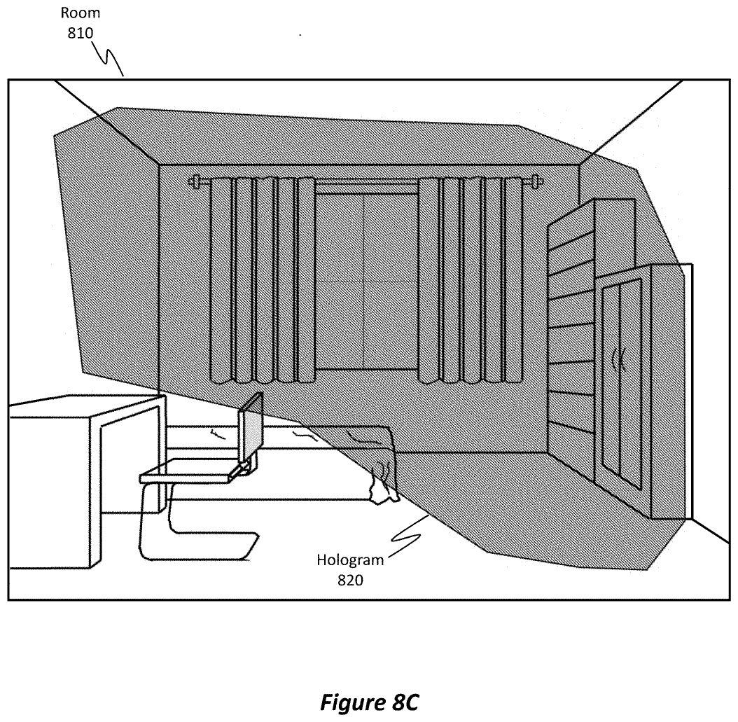

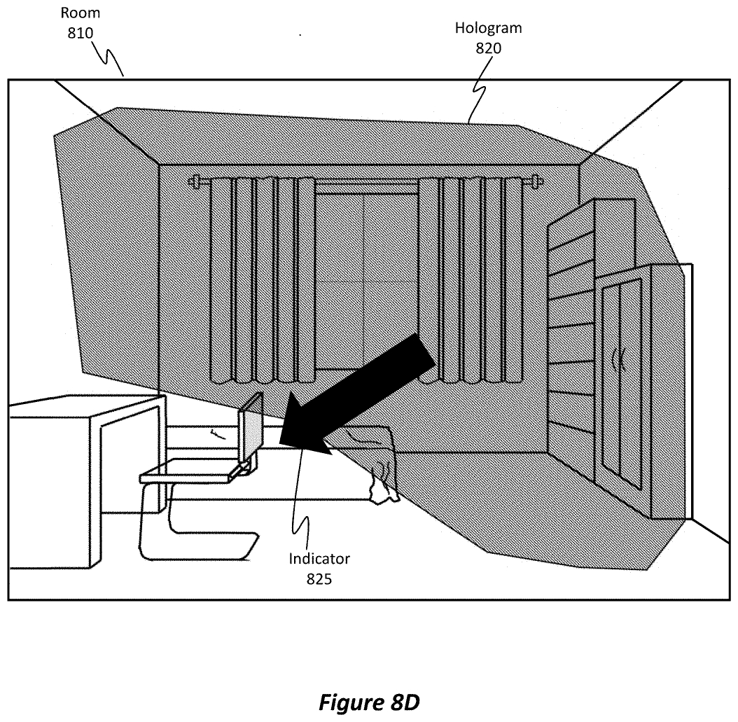

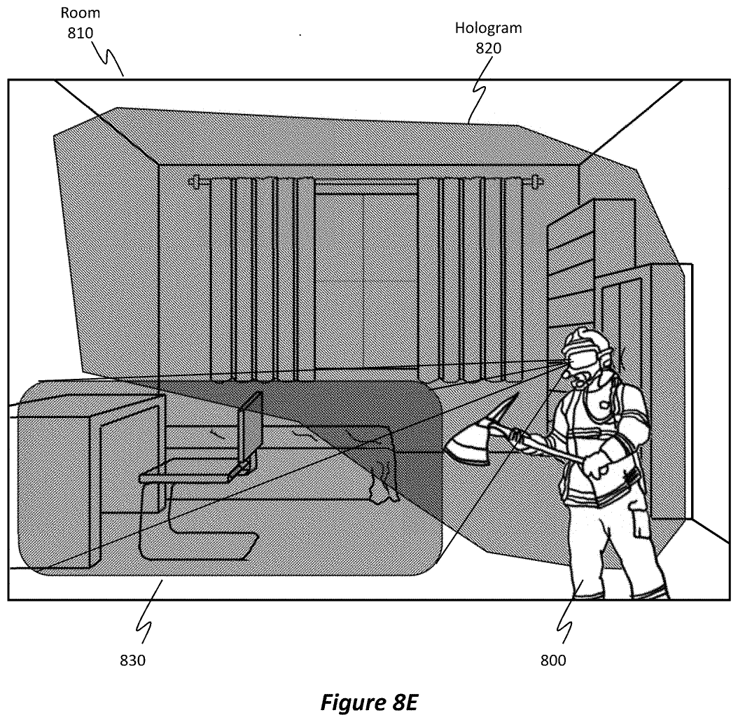

FIG. 8A illustrates a scenario in which a user 800 wearing an HMD is about to peek his/her head through a doorway 805 leading to a room 810. Instead of (or in addition to) a wire frame visualization showing the users' different paths, some embodiments are configured to display a 3D virtual image or hologram in the user's HMD to illustrate whether an area has or has not been visited or scanned by a separate HMD.

Specifically, as user 800 brings his/her HMD into room 810, the HMD can render a virtual image to inform user 800 that room 810 has already been scanned and/or visited by a different HMD. Hologram 815 in FIG. 8B is an example of such a virtual image. By way of further clarification, a separate HMD has already scanned or been inside of (e.g., cleared) room 810. As such, there is no need for user 800 to progress any further into room 810.

In some cases, hologram 815 in FIG. 8B can be a simple virtual image blanketing or visually overlapping the entirety of the user's FOV when viewing room 810. To clarify, hologram 815 can include transparent coloring, shading, or color gradients overshadowing the user's view of room 810. The color can be indicative of which specific other user/HMD previously visited room 815. In other words, each user can be associated with a particular color, and any areas previously scanned or navigated by that user can have a hologram in the user's color projected overtop of those areas within the user's HMD.

Of course, hologram 815 is not limited to just a blanket-like overlapping virtual image. In some embodiments, the other user's text name, timestamp data (e.g., when the original scan occurred), avatar, icon (e.g., a helmet), or even an image of the user's head can be used with or as the hologram 815. Combinations of these descriptive pieces of information can also be rendered.

For instance, hologram 815 can be rendered simultaneously with the other user's name, timestamp data, avatar, icon, and/or head image. As shown in FIG. 8B, timestamp hologram 815A, which is indicative of the time when the original scanning HMD scanned room 810, and icon hologram 815B, which is indicative of the original user's hat, can be displayed simultaneously with one another and with the hologram 815 to provide further information to the current user regarding who and when room 810 was originally scanned or visited.

In some cases, these virtual images (e.g., the text name, timestamp data, avatar, icon, or the head image) can also be partially transparent to allow the current user to see through the holograms into the room. In other embodiments, the holograms are not transparent and instead entirely occlude the room to prevent the user from viewing the confines or internals of room 810. Entirely occluding the room may be beneficial to clearly inform the user that the room has already been scanned. In some cases, the complete occlusion can transform into transparency as the user more fully enters room 810. The transparency can progressively increase as the HMD continues to enter the room 810. In some implementations, the virtual images can flash one or more times to alert the user that room 810 has already been scanned.

In some embodiments, hologram 815 is also associated with a sound. For instance, the HMD, in addition to (or alternative to) displaying hologram 815 can also play an audio sound to inform the current user that somebody else has already invested time in scanning room 810. The audio recording can playback the name of the original scanning user as well as when (e.g., timestamp data) the scanning occurred.

FIG. 8C shows an example scenario in which the entirety of room 810 was not previously scanned by the original scanning user. For instance, hologram 820 shows that only a portion and not the entirety of the room 810 was scanned. The areas of room 810 covered by hologram 820 represent areas that were sufficiently scanned by the original scanning HMD to allow the central processing service to generate a robust surface mesh of those areas. The areas not covered by hologram 820 may represent areas that either were not scanned at all or were not scanned to a sufficient degree so as to enable the central cloud service to generate a robust surface mesh for those areas. A scanning threshold may be used to distinguish between areas that have been sufficiently scanned to generate a robust 3D surface mesh and areas that either have not been scanned or that were not scanned for long enough to acquire a sufficient amount of detailed surface information.

In some embodiments, the scanning threshold can relate to the amount of time the scanning HMD spent in scanning the different areas. Typically, scanning a room does not require a prolonged period of time. For instance, a room can often be sufficiently scanned in under a minute. As such, the scanning threshold can be set to a specific time duration in which the HMD was used to scan the room. In some embodiments, the scanning threshold can relate to the amount of scanning data (e.g., depth images) that is acquired during the scanning process. If the amount of data satisfies a data threshold or limit, then the room can be considered to have been sufficiently scanned.

In some implementations, an indicator can be displayed in a user's HMD to inform the user regarding which specific areas of a room or environment have not been sufficiently scanned. For instance, in FIG. 8D, the user 800's HMD can render indicator 825 pointing to or otherwise emphasizing the areas in room 810 that were not sufficiently scanned. The user 800 can be guided to specific areas via indicator 825 to allow those areas to then be scanned by the HMD and/or cleared.

FIG. 8E illustrates such a scenario. In particular, indicator 825 from FIG. 8D guided user 800 over to a specific area (e.g., near the chair), and user 800's HMD is now scanning that area (as shown by scan 830). This new 3D scanning data can then be provided to the central processing service to enable the service to generate a more complete digital 3D representation of room 810. Furthermore, the central processing service can then generate updated real-time feedback data (e.g., reduced resolution representation data) and can push the updated data to the other HMDs to inform their users that this new area has now been sufficiently scanned and cleared.

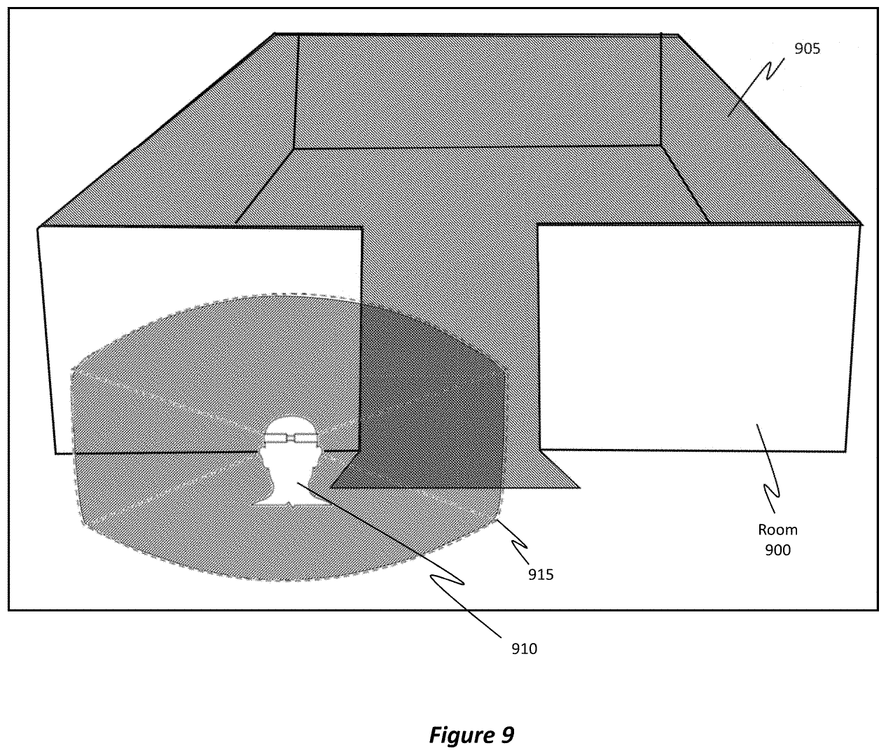

FIG. 9 shows a room 900 that was previously scanned by another HMD. Specifically, hologram 905, which was generated using reduced resolution representation data generated based on 3D scanning data acquired from another source (e.g., another HMD or the central processing service), provides a visual indication to the current user that room 900 has already been scanned. In this regard, reduced resolution representation data includes data usable to differentiate between areas in the environment that have been scanned by other computing system(s)/HMDs and areas in the environment that have not been scanned by other computing system(s)/HMDs.

To illustrate, a new user 910 is approaching the room 900. New user 910 is associated with his/her own hologram 915 indicating areas where the new user 910 has already been or already scanned. Hologram 915 is generated based on 3D scanning data generated by user 910's own HMD whereas hologram 905 is generated based on reduced resolution representation data (received at user 910's HMD) based on 3D scanning data generated by another HMD. In this scenario, hologram 915, which corresponds to user 910, is partially overlapping hologram 905, which corresponds to another user. Accordingly, multiple holograms can be visually displayed in an overlapping manner. If holograms overlap, then that may mean that multiple HMDs have scanned or been present at the same area. Furthermore, displaying the holograms operates to inform the user that room 900 does not need to be re-scanned. Thus, new user 910 can proceed to a different room.

As described earlier, each set of reduced resolution representation data can include anchor point data (e.g., anchor point data 530). This anchor point data can be provided to enable each computing system/HMD to align its corresponding 3D scanning data (e.g., perhaps its own hologram, such as hologram 915) with any received reduced resolution representation data. In other words, hologram 915 can use the same anchor points as hologram 905 to ensure that those two holograms are accurately aligned with one another and that they share the same coordinate access with regard to a known vector or anchor reference.

Some embodiments operate to limit the number of holograms that are rendered in a user's HMD. For instance, the HMD can limit rendering to only the user's current floor so that only holograms on the user's floor are displayed and so that holograms from other floors (i.e. users/HMDs on other floors) are not visible.

In some implementations, a sphere can be computed around the user's HMD to determine how far out holograms will be displayed relative to the HMD's current position or pose. The size of the sphere can be set to any value (e.g., 1 meter, 2 meters, 3, 4, 5, 6, and so on). Holograms located beyond the size of the sphere (e.g., corresponding to rooms or areas far away from the HMD) will not be projected until such time as the HMD approaches those areas. Furthermore, the sphere can also be limited or cut off to only the user's floor level. Because holograms representing the locations of other users are generated based off of reduced resolution representation data, the amount of hologram data delivered to an HMD can be limited so as to restrict the number of holograms that are displayed. In some cases, this limiting can be based on the size of the sphere created around the user's HMD.

Building on the sphere concept, the embodiments are able to limit how much data is downloaded so that only data representative of objects, areas, or rooms near the user/HMD is downloaded in the form of reduced resolution representation data. In this manner, the embodiments are able to download data representative of objects, areas, or rooms within a specified radius or distance relative to the HMD. The movements of the HMD can trigger the download of additional data (e.g., as new objects, areas, or rooms enter the radius) as well as the discard of old data (e.g., as old objects, areas, or rooms leave the radius). Accordingly, it is possible to prioritize the download of reduced resolution representation data based on objects, areas, or rooms identified as being within a determined proximity or radius of the HMD. Higher priorities can be assigned to the download of reduced resolution representation data for closer objects, areas, or rooms as compared to further away objects, areas, or rooms.

In some embodiments, the HMD can also display holograms that effectively allow a user to see through walls or other obstructions. For instance, in FIG. 9, room 900 has a number of walls. In some embodiments, user 910's HMD can display a hologram showing that room 900 has already been scanned even if the user is not near the doorway of room 900. As an example, suppose user 910's HMD was being pointed at one of the outer walls of room 900. Even though a wall is between the user's HMD and the inside of room 900, the HMD can still display a hologram indicating how room 900 has been scanned. This principle can be expanded even further to include scenarios in which the HMD displays holograms showing what is around a corner or even what is around multiple corners.

In some embodiments, a motion detection beacon can be left behind in a room that has already been cleared. If a person (e.g., an injured person) later walks into the room, that person's movements will trigger the beacon to send a signal to the HMDs to inform the users of those HMDs that the room in which the beacon is located may need to be re-cleared.

In some implementations, the resulting 3D surface mesh can also be used for training simulations or other training purposes. For instance, once the environment is mapped and captured via the 3D surface mesh, trainees wearing HMDs can subsequently rely on the mapped environment to perform training scenarios, such as by learning to efficiently and quickly clear a room.

Some embodiments are able to display pose information in addition to or alternatively to the wire frame images. For example, the position of an HMD as well as the direction it is facing (e.g., the six degrees of freedom including raw, pitch, roll, as well as XYZ) can be determined. This information can then be used to map out what a user is currently viewing. For example, a first user need not physically move to a second user's location to see what the second user is seeing at the second user's position. With the sparse or reduced resolution representation data, it is possible to convey information to the first user by showing the head pose information of the second user so the first user can see where the second user is currently looking (or perhaps where the second user was previously looking by selecting a particular timestamp associated with the second user's historical 3D scanning data).

Users are able to switch between viewing the mini-map in their HMD and viewing the different holograms. This switching can be performed by a voice activation control, by selecting a hologram to trigger a switch in the user's HMD, or even by pressing an actual hardware button. In some embodiments, the holograms can be displayed simultaneously with the mini-map in the user's HMD.

### Example Method(s)

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

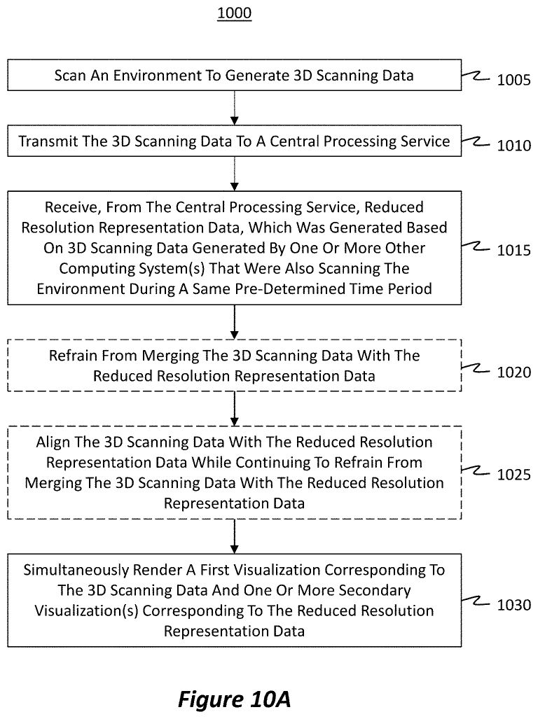

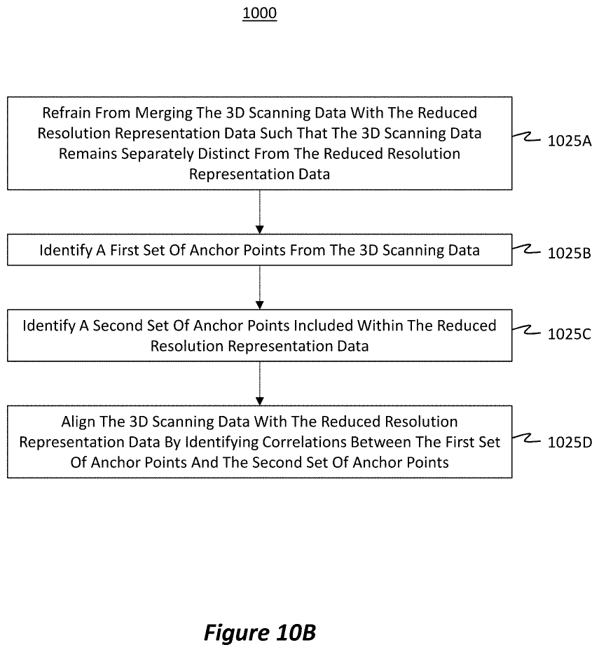

Attention will now be directed to FIG. 10A, which illustrates a flowchart of an example method 1000 for acquiring reduced resolution representation data in order to visualize where other HMDs have previously been.

Initially, method 1000 includes an act 1005 in which an environment is scanned by a computing device (e.g., an HMD/MR system, as described earlier) to generate three-dimensional (3D) scanning data of the environment. For instance, FIG. 4A showed how scanning data 405A can be generated using an HMD's scanning sensors (e.g., depth cameras).

Method 1000 also includes an act 1010 of transmitting the 3D scanning data to a central processing service (e.g., perhaps the central cloud service 420 from FIG. 4A). The 3D scanning data is configured to enable the central processing service to generate or update a digital 3D representation (e.g., digital 3D representation 425 from FIG. 4A) of the environment using the 3D scanning data.

Next, the computing system (e.g., the HMD or MR system) receives, from the central processing service, reduced resolution representation data (e.g., reduced resolution representation data 515A as shown in FIG. 5A). Here, the reduced resolution representation data was generated based on 3D scanning data generated by one or more other computing system(s) that were also scanning the environment during a same pre-determined time period in which the computer system was scanning the environment. For instance, FIG. 5A shows how reduced resolution representation data 515A was generated based on the 3D scanning data acquired for rooms D, E, F, G, H, I, J, and K. Here, HMDs 400B and 400C (not HMD 400A) were used to acquire the scanning data corresponding to those rooms (e.g., scanning data 405B and 405C, respectively). Consequently, the reduced resolution representation data received by one of the HMDs is actually based off of scanning data acquired by a different HMD.

In some embodiments (though not necessarily all, as indicated by the dashed box surrounding act 1020), method 1000 includes act 1020 in which the computing system, subsequent to receiving the reduced resolution representation data, refrains from merging or fusing its own 3D scanning data with the received reduced resolution representation data (e.g., refrains from merging the two data sets into a single surface reconstruction mesh or into a single set or composite of data). Consequently, the 3D scanning data and the reduced resolution representation data remain separately distinct from one another.

In some embodiments (again, not necessarily all), method 1000 includes an act 1025 of aligning the 3D scanning data with the reduced resolution representation data while continuing to refrain from merging the 3D scanning data with the reduced resolution representation data.

Turning briefly to FIG. 10B, this figure more fully clarifies aspects related to act 1025. For instance, in act 1025A, the method may include an act of refraining from merging the 3D scanning data with the reduced resolution representation data such that the 3D scanning data remains separately distinct from the reduced resolution representation data and such that the computer system refrains from generating a single composite of data from the 3D scanning data and the reduced resolution representation data.

Then, in act 1025B, the method may include an act of identifying a first set of anchor points from the 3D scanning data (e.g., from the anchor point data 445 shown in FIG. 4B).

Additionally, the method may include an act 1025C of identifying a second set of anchor points included within the reduced resolution representation data (e.g., from the anchor point data 530 shown in FIG. 5B).

Thereafter, the method may include an act 1025D of aligning the 3D scanning data with the reduced resolution representation data by identifying correlations between the first set of anchor points and the second set of anchor points. As an example, both sets of anchor data may include fiduciary points corresponding to the dresser corners in FIG. 3A or perhaps corresponding to the wall corners. By identifying these common fiduciary points, the embodiments are able to align the HMD's own 3D scanning data with the received reduced resolution representation data.

In some embodiments, the process of aligning the 3D scanning data with the reduced resolution representation data results in the 3D scanning data and the reduced resolution representation data sharing a same coordinate axis or a same alignment vector (e.g., a gravity vector). Accordingly, the aligning process can be performed using one or more shared anchor points that are commonly shared between the 3D scanning data and the reduced resolution representation data.

Returning to FIG. 10A, method 1000 may then include an act 1030 of simultaneously rendering (e.g., on a display of the computer system/HMD) a first visualization corresponding to the 3D scanning data (and corresponding to the HMD's position) and one or more secondary visualization(s) corresponding to the reduced resolution representation data (and corresponding to the positions of the one or more other HMD(s)). As an example, path 605B in FIG. 6 may correspond to the first visualization and paths 610B and 615B may correspond to the one or more secondary visualization(s). Additionally, hologram 915 in FIG. 9 may correspond to the first visualization while hologram 905 may correspond to the one or more secondary visualization(s).

As shown in FIG. 9, one of the first visualization (e.g., hologram 915) or the second visualization (e.g., hologram 905) can overlap the other one on the display. An overlap condition indicates that multiple HMDs may have navigated the same path or may have at least partially scanned the same area.

In some cases, the first visualization (e.g., path 605B in FIG. 6) or the second visualization (e.g., paths 610B or 615B) can be a wire frame visualization (e.g., 3D edges of a triangular mesh, or perhaps other types of 2D images). In some cases, the wire frame visualizations can include 3D point cloud visualizations such as 3D footprints or 3D breadcrumb trails. As described earlier, the phrase “wire frame” is to be interpreted broadly to include both 2D and 3D visualizations. In some embodiments (e.g., as shown in FIG. 7), the wire frame visualization(s) can be rendered in a bird's eye mini-map. In some embodiments (e.g., as shown in FIG. 9), the first visualization (e.g., hologram 915) and the second visualization (e.g., hologram 905) are both 3D holograms that are projected onto the display.

As described earlier, the coloring for the wire frame visualizations and/or the holograms can be different from one another and can be linked or otherwise attributed to specific users. As such, a displayed color of the hologram for the first visualization can be different than a displayed color of the hologram for the second visualization.

In this manner, the first or second visualizations can include one of: two-dimensional (2D) wire frame visualizations or 3D holograms. Furthermore, as described in connection with FIG. 8D, the secondary visualization(s) can include an indicator indicating whether a particular area within the environment, which particular area was scanned by another HMD, requires additional scanning by the HMD in order to provide the central processing service with additional scanning data. This additional scanning data may be needed to ensure that a quality level of the 3D surface mesh satisfies a required quality level for that particular area.

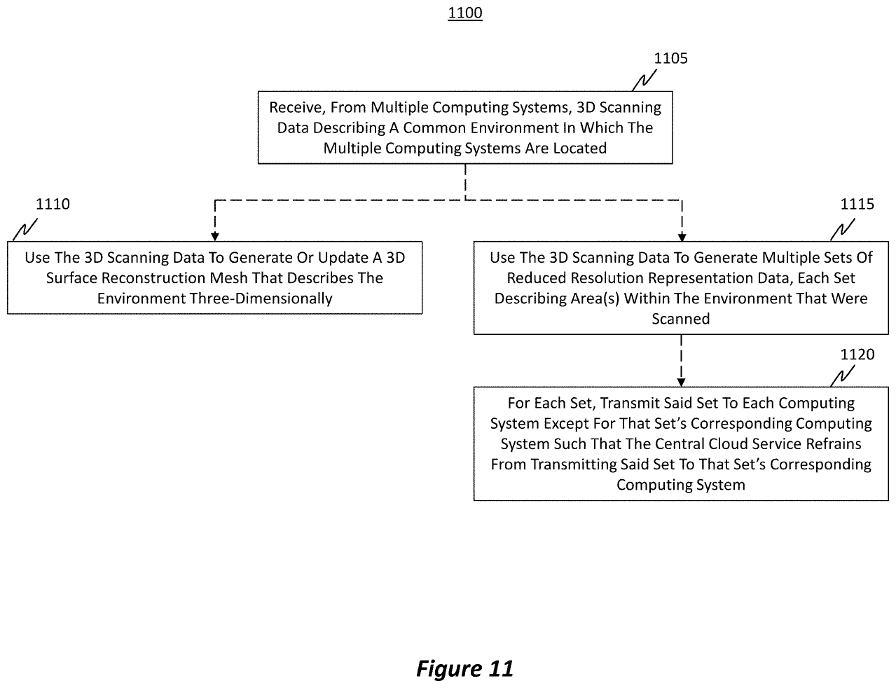

FIG. 11 illustrates a flowchart of an example method 1100 that may be performed by any of the central processing services described thus far. In particular, method 1100 can be performed by a central processing service (e.g., operating on a cloud server or an on-premises local server) to provide feedback data to multiple computing systems to enable those multiple computing systems to visually differentiate between areas in an environment that have been scanned via surface reconstruction scanners (e.g., up to at least a particular scanning threshold) and areas in the environment that have not been scanned via the surface reconstruction scanners (e.g., up to the particular scanning threshold).

Initially, method 1100 includes an act 1105 of receiving, from the multiple computing systems, three-dimensional (3D) scanning data describing a common environment in which the multiple computing systems are located. FIG. 4A illustrated how the central cloud service 420, which may be representative of a central processing service, is able to receive scanning data.

In some cases, the common environment is a building in which the multiple computing systems are located, as shown in the earlier figures. Here, a first computing system (e.g., an HMD) can be located in a first room of the building while a second computing system can be located in a second room of the building, with the second room being different than the first room. An example of this scenario is shown in FIG. 6 where the icons 605A, 610A, and 615A are representative of different computing systems (i.e. HMDs).

Subsequent to receiving the 3D scanning data, the central processing service can perform a number of different operations. For instance, as shown by act 1110, the central processing service can use the 3D scanning data to start generating a 3D surface reconstruction mesh that describes the environment three-dimensionally or, alternatively, to update an existing 3D surface reconstruction mesh. Updates may occur incrementally (e.g., once a threshold amount of new 3D scanning data is received or once a buffer is filled with new 3D scanning data, where the update triggers emptying the buffer to start anew), or the updates can occur immediately in response to receiving new 3D scanning data.

Either in parallel with act 1110 or in serial with act 1110, the central processing service can then use (e.g., as shown by act 1115) the 3D scanning data to generate multiple sets of reduced resolution representation data (e.g., reduced resolution representation data 515A, 515B, and 515C from FIG. 5A). As further shown by FIG. 5A, a corresponding set is generated for each one of the multiple computing systems. Furthermore, each set of reduced resolution representation data describes one or more area(s) within the environment that were scanned up to the particular scanning threshold by that set's corresponding computing system. As an example, reduced resolution representation data 515A includes data for rooms D, E, F, G, H, I, J, and K while the other sets of data include information for other combinations of rooms.

Then, for each set of reduced resolution representation data, the central processing service transmits (act 1120) the set to each computing system included among the multiple computing systems except for that set's corresponding computing system. Consequently, the central processing service refrains from transmitting the set to that set's corresponding computing system. As an additional consequence, the central processing service sends to each computing system included among the multiple computing systems reduced resolution representation data generated by a different computing system. For instance, in FIG. 5A, the HMD 520A does not need reduced resolution representation data for rooms A, B, and C because HMD 520A itself has already scanned those rooms. Instead, HMD 520A receives reduced resolution representation data only for rooms D, E, F, G, H, I, J, and K.

Accordingly, the disclosed embodiments significantly improve the technical field by providing so-called “reduced resolution representation data.” This data is used to inform users of HMDs where other users have already been within an environment. Such operations can significantly improve the efficiency and timing by which an environment is cleared, swept, and/or scanned.

### Example Computer Systems

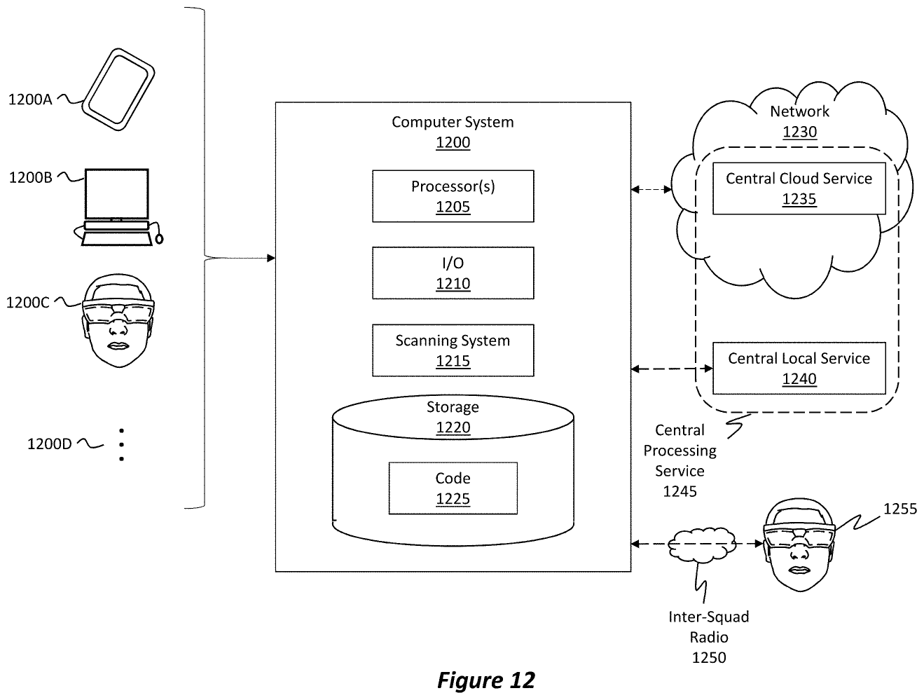

Attention will now be directed to FIG. 12 which illustrates an example computer system 1200 that may include and/or be used to perform the operations described herein. In particular, this computer system 1200 may be in the form of the MR systems/devices, computer systems, or HMDs that were described earlier. As such, the computer system may be one of the following: a virtual-reality system or an augmented-reality system.

Computer system 1200 may take various different forms. For example, in FIG. 12, computer system 1200 may be embodied as a tablet 1200A, a desktop 1200B, or an HMD 1200C (with a corresponding wearable display), such as those described throughout this disclosure. The ellipsis 1200D demonstrates that computer system 1200 may be embodied in any form.

Computer system 1200 may also be a distributed system that includes one or more connected computing components/devices that are in communication with computer system 1200, a laptop computer, a mobile phone, a server, a data center, and/or any other computer system. The ellipsis 1200D also indicates that other system subcomponents may be included or attached with the computer system 1200, including, for example, sensors that are configured to detect sensor data such as user attributes (e.g., heart rate sensors), as well as sensors like cameras and other sensors that are configured to detect sensor data such as environmental conditions and location/positioning (e.g., clocks, pressure sensors, temperature sensors, gyroscopes, accelerometers and so forth), all of which sensor data may comprise different types of information used during application of the disclosed embodiments and which may be included as a part of the 3D scanning data described herein. Some of the embodiments are implemented as handheld devices or handheld depth cameras. Some embodiments are also operable in robotics, drones, ambient settings, and any type of mobile phone.

In its most basic configuration, computer system 1200 includes various different components. FIG. 12 shows that computer system 1200 includes at least one processor(s) 1205 (aka a “hardware processing unit”), input/output (“I/O”) 1210, scanning system 1215, and storage 1220.

I/O 1210 may include any number of input/output devices, including wearable or handheld devices. I/O 1210 may also include a wearable display, which may be used to render virtual content. Scanning system 1215 may include any number of scanning sensors or depth cameras, including head tracking sensors, hand tracking sensors, depth detection sensors, or any other type of depth camera. These depth cameras may be configured in the manner described earlier to scan an environment to generate 3D scanning data, and the scanning system 1215 may perform any of the disclosed scanning.

Storage 1220 is shown as including executable code/instructions 1225. The executable code/instructions 1225 represent instructions that are executable by computer system 1200 to perform the disclosed operations, such as those described in the methods of FIGS. 10A, 10B, and 11.

Storage 1220 may be physical system memory, which may be volatile, non-volatile, or some combination of the two. The term “memory” may also be used herein to refer to non-volatile mass storage such as physical storage media. If computer system 1200 is distributed, the processing, memory, and/or storage capability may be distributed as well. As used herein, the term “executable module,” “executable component,” or even “component” can refer to software objects, routines, or methods that may be executed on computer system 1200. The different components, modules, engines, and services described herein may be implemented as objects or processors that execute on computer system 1200 (e.g. as separate threads).

The disclosed embodiments may comprise or utilize a special-purpose or general-purpose computer including computer hardware, such as, for example, one or more processors (such as processor(s) 1205) and system memory (such as storage 1220), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are physical/hardware computer-readable storage media/device(s). Computer-readable media that carry computer-executable instructions are transmission media. Thus, by way of example and not limitation, the current embodiments can comprise at least two distinctly different kinds of computer-readable media: computer storage media/device(s) and transmission media.

Computer storage media are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1200 may also be connected (via a wired or wireless connection) to external sensors (e.g., one or more remote cameras, accelerometers, gyroscopes, acoustic sensors, magnetometers, etc.) or devices/HMDs via a network 1230. For example, computer system 1200 can communicate with a central cloud service 1235 located in the cloud or with a central local service 1240 located locally relative to the computer system 1200 (e.g., an on-premise computer). The central cloud service 1235 or the central local service 1240 can operate as the disclosed central processing service 1245 discussed throughout this disclosure. As such, a remote-based cloud service or a local service can perform the disclosed operations. Furthermore, computer system 1200 may also be connected via an inter-squad radio 1250 to one or more other HMDs 1255 to thereby transmit and/or receive data directly from those other HMDs (e.g., without passing through an intermediary server or service). Use of the phrase “directly” does not necessarily mean a 1-to-1 communication. Rather, “directly” simply means that the communication does not have to utilize the central cloud service or the central local service. Indeed, the communication may rely on any number of other intermediary devices, such as routers, switches, and so forth.

During use, a user of computer system 1200 is able to perceive information (e.g., an MR scene/environment (including VR or AR)) through a display screen that is included with the I/O 1210 of computer system 1200 and that is visible to the user. The I/O 1210 and sensors with the I/O 1210 also include gesture detection devices, eye trackers, and/or other movement detecting components (e.g., cameras, gyroscopes, accelerometers, magnetometers, acoustic sensors, global positioning systems (“GPS”), etc.) that are able to detect positioning and movement of one or more real-world objects, such as a user's hand, a stylus, and/or any other object(s) that the user may interact with while being immersed in the mixed-reality environment.

A graphics rendering engine may also be configured, with processor(s) 1205, to render one or more virtual objects within an MR scene. As a result, the virtual objects accurately move in response to a movement of the user and/or in response to user input as the user interacts within the virtual scene.

A “network,” like the network 1230 shown in FIG. 12, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1200 will include one or more communication channels that are used to communicate with the network 1230. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RANI and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

Additionally, or alternatively, the functionality described herein can be performed, at least in part, by one or more hardware logic components (e.g., the processor(s) 1205). For example, and without limitation, illustrative types of hardware logic components that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), and other types of programmable hardware.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processor(s); and
one or more computer-readable hardware storage device(s) having stored thereon computer-executable instructions that are executable by the one or more processor(s) to cause the computer system to:
for an environment in which the computer system is located, scan the environment to generate three-dimensional (3D) scanning data of the environment;
transmit the 3D scanning data to a central processing service, the 3D scanning data being configured to enable the central processing service to generate a digital 3D representation of the environment using the 3D scanning data;
receive, from the central processing service, reduced resolution representation data, wherein the reduced resolution representation data was generated based on 3D scanning data generated by one or more other computing system(s) that were also scanning the environment during a same pre-determined time period in which the computer system was scanning the environment; and
on a display of the computer system, simultaneously render a first visualization corresponding to the 3D scanning data and one or more secondary visualization(s) corresponding to the reduced resolution representation data.

2. The computer system of claim 1, wherein one of the first visualization or the second visualization overlaps the other one on the display.

3. The computer system of claim 1, wherein the first visualization or the second visualization is a wire frame visualization.

4. The computer system of claim 3, wherein the wire frame visualization is rendered in a bird's eye mini-map.

5. The computer system of claim 1, wherein the first visualization and the second visualization are both holograms that are projected onto the display.

6. The computer system of claim 5, wherein a displayed color of the hologram for the first visualization is different than a displayed color of the hologram for the second visualization.

7. The computer system of claim 1, wherein transmitting or receiving data, including the 3D scanning data or the reduced resolution representation data, with the central processing service is performed using at least one of: a wireless fidelity (Wi-Fi) network via one or more router(s), a radio network, or a different wireless or wired broadband network, and
wherein execution of the computer-executable instructions further causes the computer system to:
refrain from merging the 3D scanning data with the reduced resolution representation data such that the 3D scanning data remains separately distinct from the reduced resolution representation data and such that the computer system refrains from generating a single composite of data from the 3D scanning data and the reduced resolution representation data;
identify a first set of anchor points from the 3D scanning data;
identify a second set of anchor points included within the reduced resolution representation data; and
align the 3D scanning data with the reduced resolution representation data by identifying correlations between the first set of anchor points and the second set of anchor points.

8. The computer system of claim 1, wherein the reduced resolution representation data is received from the central processing service within a pre-determined time period subsequent to the one or more other computing system(s) scanning the environment such that the reduced resolution representation data constitutes real-time feedback data.

9. The computer system of claim 1, wherein the computer system refrains from fusing the 3D scanning data with the reduced resolution representation data into a single composite of data such that the 3D scanning data remains separately distinct from the reduced resolution representation data.

10. The computer system of claim 1, wherein the reduced resolution representation data includes data differentiating between areas in the environment that have been scanned by the one or more other computing system(s) and areas in the environment that have not been scanned by the one or more other computing system(s).

11. A method for providing feedback data to multiple computing systems to enable said multiple computing systems to visually differentiate between areas in an environment that have been scanned via surface reconstruction scanners up to at least a particular scanning threshold and areas in the environment that have not been scanned via said surface reconstruction scanners up to the particular scanning threshold, the method being performed by a central processing service and comprising:
receiving, from the multiple computing systems, three-dimensional (3D) scanning data describing a common environment in which the multiple computing systems are located; and
subsequent to receiving the 3D scanning data, performing the following:
use the 3D scanning data to start generating a 3D surface reconstruction mesh that describes the environment three-dimensionally or, alternatively, to update the 3D surface reconstruction;
use the 3D scanning data to generate multiple sets of reduced resolution representation data, with a corresponding set being generated for each one of the multiple computing systems, wherein each set of reduced resolution representation data describes one or more area(s) within the environment that were scanned up to the particular scanning threshold by that set's corresponding computing system; and
for each set of reduced resolution representation data, transmit said set to each computing system included among the multiple computing systems except for that set's corresponding computing system such that the central processing service refrains from transmitting said set to that set's corresponding computing system and such that the central processing service sends to each computing system included among the multiple computing systems reduced resolution representation data generated from 3D scanning data acquired by a different computing system.

12. The method of claim 11, wherein each set of reduced resolution representation data includes anchor point data, which is provided to enable each computing system included among the multiple computing systems to align its corresponding 3D scanning data with any received reduced resolution representation data.

13. The method of claim 11, wherein the common environment is a building in which the multiple computing systems are located, and wherein a first computing system included among the multiple computing systems is located in a first room of the building while a second computing system included among the multiple computing systems is located in a second room of the building, the second room being different than the first room.

14. The method of claim 11, wherein the central processing service transmits the sets of reduced resolution representation data to the multiple computing systems within a pre-determined time period subsequent to the central processing service receiving the 3D scanning data such that the sets of reduced resolution representation data constitute live feedback from the central processing service.

15. The method of claim 11, wherein the sets of reduced resolution representation data are generated based on the 3D scanning data, and wherein each set of reduced resolution representation data includes a fraction of data included in the 3D scanning data such that each set of reduced resolution representation data describes the environment only to a partial extent as opposed to a full extent.

16. The method of claim 11, wherein the central processing service generates a blueprint of the common environment using the 3D scanning data.

17. A head-mounted device (HMD) comprising:
a display;
one or more processor(s); and
one or more computer-readable hardware storage device(s) having stored thereon computer-executable instructions that are executable by the one or more processor(s) to cause the HMD to:
for an environment in which the HMD is located, scan the environment to generate three-dimensional (3D) scanning data of the environment;
transmit the 3D scanning data to a central processing service, the 3D scanning data being configured to enable the central processing service to generate a 3D surface mesh of the environment using the 3D scanning data;
receive, from the central processing service, reduced resolution representation data, wherein the reduced resolution representation data was generated based on 3D scanning data generated by one or more other HMD(s) that were also scanning the environment during a same pre-determined time period in which the HMD was scanning the environment;
subsequent to receiving the reduced resolution representation data, refrain from merging the 3D scanning data with the reduced resolution representation data such that the 3D scanning data and the reduced resolution representation data remain distinct from one another;
align the 3D scanning data with the reduced resolution representation data while continuing to refrain from merging the 3D scanning data with the reduced resolution representation data; and
on the display, simultaneously render a first visualization corresponding to the 3D scanning data and one or more secondary visualization(s) corresponding to the reduced resolution representation data, which was generated based on the 3D scanning data generated by the one or more other HMD(s).

18. The HMD of claim 17, wherein aligning the 3D scanning data with the reduced resolution representation data results in the 3D scanning data and the reduced resolution representation data sharing a same coordinate axis, and wherein the aligning is performed using one or more shared anchor points that are commonly shared between the 3D scanning data and the reduced resolution representation data.

19. The HMD of claim 17, wherein the first visualization and the second visualization include one of: two-dimensional (2D) wire frame, 3D point cloud visualizations, or 3D holograms.

20. The HMD of claim 17, wherein the one or more secondary visualization(s) include an indicator indicating whether a particular area within the environment, which particular area was scanned by the one or more other HMD(s), requires additional scanning by the HMD in order to provide the central processing service with additional scanning data, the additional scanning data being needed to ensure that a quality level of the 3D surface mesh satisfies a required quality level for that particular area.
